(19) United States
(12) Patent Application Publication
(10) Pub. No.: US 2025/0169506 A1
(43) Pub. Date: May 29, 2025

(54) PLANT GROWING COMPOSITE, METHOD FOR MANUFACTURING PLANT GROWING COMPOSITE, AND METHOD FOR GROWING PLANT

(71) Applicant: SUNLIT SEEDLINGS LTD., Kyoto (JP)

(72) Inventor: Sota ISHIKAWA, Kyoto (JP)

(21) Appl. No.: 18/842,830

(22) PCT Filed: Feb. 27, 2023
(86) PCT No.: PCT/JP2023/007047

§ 371 Date: Aug. 30, 2024

(30) Foreign Application Priority Data
Mar. 1, 2022 (JP) 2022-030704

(51) Int. Cl. A01N 63/38; A01N 25/02; A01P 3/00; A01P 21/00

(52) U.S. Cl. CPC A01N 63/38; A01N 25/02; A01P 3/00; A01P 21/00

(57) ABSTRACT

A plant growing composite produces intended effects and has measures against artificial diffusion of gene resources. The plant growing composite is applied to a growing plant before, after, or before and after the growing plant is planted. The growing plant is a plant to be planted at a planting site and grown artificially. The plant growing composite includes a liquid substrate, and a mycelium of a functional filamentous fungus that is nonmycorrhizal. The functional filamentous fungus has a function contributable to growth or a growing environment of the growing plant. The functional filamentous fungus is derived from a nonmycorrhizal filamentous fungus isolated from a sample collected from the planting site or a neighborhood of the planting site. A method for manufacturing the plant growing composite and a method for growing a plant with the plant growing composite are also described.

### FIELD

The disclosure relates to a plant growing composite to be applied to a growing plant and a method for manufacturing the plant growing composite. The disclosure also relates to a method for growing a plant using the plant growing composite.

### BACKGROUND

Plants have been artificially grown for agriculture and forestry or green space creation using various materials or devices. Examples of such materials include fertilizers containing nutrients to promote plant growth, soil improvers for improving the physicochemical properties of soil, and pesticides for protecting plants from disease-causing pests (hereafter, fertilizers, soil improvers, and pesticides may be collectively referred to as plant cultivation materials).

Chemically synthesized fertilizers (chemical fertilizers) provide, among the plant cultivation materials, nutrients such as nitrogen or phosphorus to the plants in a form easily absorbable by the plants (specifically, as inorganic matter). Chemical fertilizers can thus easily function and have been widely used. Chemically synthesized pesticides (chemical pesticides) are chemical substances having the mechanism to kill insects or microorganisms. The chemical pesticides function rapidly and reliably, and have been widely used similarly to the chemical fertilizers.

Although such chemical fertilizers or chemical pesticides function reliably and effectively, they largely affect the ecosystems of agricultural or forest land. For environmental conservation, plant cultivation materials that can replace chemical fertilizers and chemical pesticides or plant growing methods free of chemical substances have been increasingly awaited. Under such circumstances, a technique for using, as pesticides, microorganisms that provide protection against pathogens has been developed. For example, Patent Literature 1 describes microbial pesticides prepared by pulverizing a culture of fungi of Trichoderma genus, which are nonmycorrhizal filamentous fungi, on a solid medium (grain seeds or refined seeds of the grain).

The fungi of Trichoderma genus used as microbial pesticides in Patent Literature 1 are filamentous fungi (also referred to as fungi), which are typically multicellular organisms that form mycelia. Known filamentous fungi include mycorrhizal filamentous fungi (mycorrhizal fungi) that establish a symbiotic relationship with a plant by forming a mycorrhiza and nonmycorrhizal filamentous fungi that does not form a mycorrhiza. The fungi of Trichoderma genus correspond to nonmycorrhizal filamentous fungi. The nonmycorrhizal filamentous fungi can be grown without forming a mycorrhiza on plant roots (with, for example, an artificial medium), and thus be easily cultured. Filamentous fungi may also be referred to as, for example, molds or mushrooms, and may be disease fungi for crops to be avoided at agriculture sites.

However, some species of filamentous fungi have functions beneficial to the growth of plants. The fungi of Trichoderma genus described in Patent Literature 1 are known to protect plants from disease.

### CITATION LIST

### Patent Literature

Patent Literature 1: WO2017/188051

### SUMMARY

A plant growing composite produces intended effects and has measures against artificial diffusion of gene resources. The plant growing composite is applied to a growing plant before, after, or before and after the growing plant is planted. The growing plant is a plant to be planted at a planting site and grown artificially. The plant growing composite includes a liquid substrate, and a mycelium of a functional filamentous fungus that is nonmycorrhizal. The functional filamentous fungus has a function contributable to growth or a growing environment of the growing plant. The functional filamentous fungus is derived from a nonmycorrhizal filamentous fungus isolated from a sample collected from the planting site or a neighborhood of the planting site. The mycelium constitutes more than or equal to 50% of the functional filamentous fungus included in the plant growing composite. A method for manufacturing the plant growing composite and a method for growing a plant with the plant growing composite are also described.

### BRIEF DESCRIPTION OF DRAWINGS

FIG. 1 is a set of photos of isolate cultures of growth promotion filamentous fungi and protection filamentous fungi specified in Example 1.

FIG. 2 is a photo of a liquid formulation obtained by growing nonmycorrhizal filamentous fungi obtained in Example 1 in a liquid medium containing a growth substrate of the filamentous fungi as a mycelium.

FIG. 3 is a set of photos of the roots of containerized seedlings (Japanese cypress) in Example 1 and Comparative Example 1, showing the growing state.

FIG. 4 is a set of photos of compost for growing a seedling of Welsh onion and tomato in Example 2 (on the right) and Comparative Example 2 (on the left), showing the state in which pathogenic fungi are dominant.

FIG. 5 is an optical microscopic photo of a plant growing composite in Example 3.

FIG. 6 is an optical microscopic photo of a sporophyte of filamentous fungi of the same species as the filamentous fungi in FIG. 5.

### DESCRIPTION OF EMBODIMENTS

The pesticide formulated composite described in Patent Literature 1 has effects to be improved. The pesticide formulated composite in Patent Literature 1 is a solid culture (specifically, a dry culture) of fungi of Trichoderma genus. The fungi of Trichoderma genus contained in the composite are seemingly mostly a sporophyte or an acervulus. A sporophyte or an acervulus is a dormant state for filamentous fungi, and thus the filamentous fungi in that state have low activity.

Additionally, the pesticide formulated composite described in Patent Literature 1 is not designed to prevent artificial diffusion of gene resources.

In response to the above issue, one or more aspects of the disclosure are directed to a plant growing composite that produces intended effects and has measures against artificial diffusion of gene resources.

In response to the above issue, an aspect provides a plant growing composite to be applied to a growing plant before, after, or before and after the growing plant is planted. The growing plant is a plant to be planted at a planting site and grown artificially. The plant growing composite includes a liquid substrate, and a mycelium of a functional filamentous fungus that is nonmycorrhizal. The functional filamentous fungus has a function contributable to growth or a growing environment of the growing plant. The functional filamentous fungus is derived from a nonmycorrhizal filamentous fungus isolated from a sample collected from the planting site or a neighborhood of the planting site.

Being applied herein includes the plant growing composite being directly introduced into a cultivation system of a growing plant and the composite being introduced into a cultivation system of a growing plant after undergoing a process (e.g., dilution, concentration, mixing with another plant growing composite, and adding an additive). Being liquid herein generally refers to having liquid-like fluidity at least at normal temperature (e.g., about 10 to 35° C.: the same applies hereafter). A liquid object (such as a substrate) may thus contain, for example, insoluble particles in addition to aqueous components. The nonmycorrhizal filamentous fungus refers to a filamentous fungus that does not form a mycorrhiza at plant roots. The nonmycorrhizal filamentous fungus may also refer to all the filamentous fungi excluding mycorrhizal fungi. Hereafter, the plant growing composite may be referred to as a liquid formulation, a mycelium-containing liquid formulation, or a microorganism liquid formulation.

The plant growing composite according to the above aspect of the disclosure thus produces intended effects and has measures against artificial diffusion of gene resources.

### 1. Overview of Plant Growing Composite

A plant growing composite is applied to a growing plant to be planted at a planting site and artificially grown. The composite is applied before, after, or both before and after planting. The plant growing composite contains a liquid substrate, and a mycelium of a nonmycorrhizal functional filamentous fungus having a function beneficial to the growth or the growing environment of the growing plant. The mycelium has higher metabolism than a sporophyte or an acervulus. Thus, the plant growing composite containing the mycelium can enhance the functions of the functional filamentous fungus more effectively than a known pesticide formulated composite containing spores and conidia as main components. After being applied, the plant growing composite can produce its effects relatively rapidly. The percentage of the mycelium (mycelium percentage) in the functional filamentous fungus included in the plant growing composite is 50 to 100% inclusive in some embodiments, 70 to 100% inclusive in some embodiments, 80 to 100% inclusive in some embodiments, 90 to 100% inclusive in some embodiments, 95 to 100% in some embodiments, and 98 to 100% inclusive in some embodiments.

The functional filamentous fungus contained in the plant growing composite is derived from nonmycorrhizal filamentous fungi isolated from a sample collected from a planting site at which the growing plant is planted (or is to be planted for pre-planted plants: the same applies hereafter) or the neighborhood of the planting site. Thus, when a seedling of the growing plant to which the plant growing composite is applied is planted at the planting site or when the plant growing composite is applied to the growing plant planted at the planting site, gene resources are less likely to be artificially diffused. A growing plant and a functional filamentous fungus having higher compatibility with each other may allow the functional filamentous fungus to function more effectively.

The substrate in the plant growing composite is in a liquid state at normal temperature (in other words, the entire plant growing composite has liquid-like fluidity). The plant growing composite can thus be applied in various manners. The plant growing composite can be applied with fewer timing constraints and thus is convenient. More specifically, for example, to apply the plant growing composite to the subterranean part (such as roots) of the growing plant, the cultivation soil in which the growing plant is yet to be planted may be pre-wetted with the composite, the soil in which a plant body or a seed of the growing plant is planted may be irrigated with the composite, or the pot or other containers in which the seed or the plant body of the growing plant is planted may be soaked in the composite. When the growing plant is grown using hydroponics, the plant growing composite may be mixed in the growing solution for hydroponics or may be used as a growing solution for hydroponics. When applied to a terrestrial part (e.g., leaf, stem, fruit, or flower) of the growing plant, the plant growing composite can be easily applied to the growing plant by, for example, being sprinkled on the terrestrial part or by allowing the terrestrial part to be soaked in the composite.

Functional filamentous fungi have functions beneficial to the growth or the growing environment of a growing plant. Examples of the functions beneficial to the growth of the growing plant include, but are not limited to, promoting the growth of a growing plant, protecting a growing plant against at least one of a disease fungus or a pest, increasing the diversity of rhizosphere biomes of a growing plant, enhancing resistance of a growing plant against abiotic stress (e.g., drought damage, high temperature injury; salt damage, cold-weather damage, frost damage, damage from active oxygen, hail damage, wind damage, damage from agricultural chemicals such as pesticides: the examples are not limited to such damage), and modifying rhizosphere biomes for a growing plant. For example, the functional filamentous fungus having the biome modification function can adjust unbalanced soil biomes at the planting site to soil biomes suitable for the growth of a growing plant by modifying the species constitution or the system construction in the biomes. The rhizosphere refers to an area including the roots of a plant and a support (e.g., natural soil, artificial soil, cultivation water-absorbing polymer, and a sponge root support for hydroponics: the examples are not limited such supports and the same applies hereafter) that supports the plant roots. The same applies hereafter.

The functions beneficial to the growing environment of a growing plant do not directly contribute to the growth of a growing plant, but can adjust the growing environment of a growing plant. Examples of such functions include, but are not limited to, improving acclimation (e.g., carbon fixation power) of a growing plant to reduce emission of greenhouse gases and reducing greenhouse gases.

The functional filamentous fungi may have two or more functions beneficial to the growth or the growing environment of the growing plant. Hereafter, the functions beneficial to the growth or the growing environment of the growing plant may be referred to as adjusting functions. A functional filamentous fungus having a function beneficial to a growing plant may be referred to as a contributing-function filamentous fungus. A functional filamentous fungus having a function beneficial to the growing environment of a growing plant may be referred to as an environment control filamentous fungus.

The functional filamentous fungus can be specified as having the function of promoting the growth of a specific growing plant in the manner described below: More specifically, growing plants to which the plant growing composite containing the functional filamentous fungus is applied and left for a predetermined period are used as an applied group. Growing plants to which a liquid (specifically, substrate) not containing the functional filamentous fungus is applied and left for the predetermined period are used as a control group. When the weight or the length of the entire or a part of the plant bodies in the applied group is statistically significantly greater than that in the control group, the functional filamentous fungus is specified as having the function of promoting the growth of the growing plants. The growth promotion function may promote the growth of the entire plant bodies of the growing plants or a part of the plant bodies of the growing plants. Examples of the growth promotion function may include promoting rooting of growing plants to increase the amount of the roots, promoting the growth of terrestrial parts of the growing plants, and reducing disease-causing pests by modifying the constitution of biomes in rhizosphere of the growing plants.

The functional filamentous fungus can be specified as having a protection function against a specific disease fungus in the manner described below (hereafter, the fungus to be prevented may be referred to as a target disease germ). More specifically, when the functional filamentous fungus and the target disease germ are cocultured on a solid medium, the target disease germ may be inhibited from growing or extending the mycelia, killed, or both inhibited and killed. In such cases, the functional filamentous fungus is specified as having the function of protecting a plant against the disease fungi. Another method includes applying the plant growing composite containing the functional filamentous fungus to the soil containing the target disease germ (e.g., applying about 30 to 80 ml of the composite, or 50 ml in some embodiments, to about 200 ml of soil containing the target disease germ) and performing amplicon sequence analysis on the microbiome in the soil before the composite is applied and a predetermined period (e.g., about one to three weeks, or about two weeks in some embodiments) after the composite is applied. When the relative quantity of genome of the target disease germ is significantly reduced, the functional filamentous fungus is specified as having the function of reducing the target disease germ.

The target disease germ is any fungus that can cause disease on at least one species of plant. The target disease germ may be a fungus (e.g., filamentous fungus), a bacterium, a virus, or an archaebacterium. Examples of the target disease germ that is a fungus include, but are not limited to, pathogens of yellows, fusarium sp., powdery mildew; phytophthora rot, leaf spot, sclerotial disease, rust, damping-off, anthracnose, fusarium wilt, damping-off, clubroot, white leaf spot, verticillium wilt, downy mildew; root rot, stem rot, white rot, and foot rot (such as sweet potato foot rot). Examples of the target disease germ that is a fungus include, but are not limited to, fungi of Fusarium genus, Sclerotium cepivorum, Verticillium genus, fungi of Rhizoctonia genus, fungi of Pythium genus, Plasmodiophora brassicae, fungi of Phytophthora genus, Pectobacterium carotovorum, fungi of Alternaria genus, fungi of Pseudoperonospora genus, fungi of Peronospora genus, fungi of Plasmopara genus, fungi of Bremia genus, fungi of Albugo genus, fungi of Puccinia genus, fungi of Botrytis genus, fungi of Colletotrichum genus, fungi of Glomerella genus, fungi of Cercospora genus, fungi of Cercosporella genus, fungi of Mycovellosiella genus, and fungi of Diaporthe genus (such as Diaporthe destruens). Examples of the target disease germ that is a bacterium include, but are not limited to, pathogens of bacterial wilt, yellows, black rot, soft rot, and fruit rot. Examples of the target disease germ that is a virus include, but are not limited to, viruses causing virus mosaic, spotted wilt, Oryza sativa stripe, and leaf curl.

The functional filamentous fungus can be specified as having the function of preventing a specific pest in the manner described below (hereafter, the insect to be prevented may be referred to as a target pest). More specifically, living target pests soaked for one second in the plant growing composite containing the functional filamentous fungus are used as a fungus contact group, and living target pests soaked for the same period in a substrate not containing the functional filamentous fungus are used as a control group. The target pests in both groups are kept for days (about one to two weeks) after being soaked. When the fungus contact group has a statistically significantly higher death rate than the control group, the functional filamentous fungus can be specified as having the function of reducing the target pests.

The target pest may be any species that can damage at least one species of plant (with vermin damage, sap-sucking, or disease). Examples of the target pest include, but are not limited to, organisms belonging to Nemathelminthes, Mollusca, and Arthropoda. Examples of the target pest include, but are not limited to, organisms belonging to Thysanoptera, Hemiptera, Coleoptera, Acarina, Lepidoptera, Diptera, Orthoptera, Hymenoptera, Tylenchida, Stylommatophora, and Isopoda.

The functional filamentous fungus can be specified as having a diversity increase function in the manner described below: More specifically, the plant growing composite containing the functional filamentous fungus is applied to test soil (e.g., soil at the planting site of the growing plant: the same applies hereafter). For example, about 30 to 80 ml, or 50 ml in some embodiments, of the composite is applied to about 200 ml of test soil. Amplicon sequence analysis is performed on the microbiome in the test soil before the composite is applied and a predetermined period (e.g., about one to three weeks, or about two weeks in some embodiments) after the composite is applied. When the diversity (e.g., the quantity of genera) of the microbiome in the test soil is significantly increased, the functional filamentous fungus is specified as having a diversity increase function.

The functional filamentous fungus can be specified as having a resistance enhancing function for a specific growing plant in the manner described below. More specifically, growing plants to which the plant growing composite containing the functional filamentous fungus is applied and left for a predetermined period are used as an applied group, and growing plants to which a liquid (specifically, substrate) not containing the functional filamentous fungus is applied and left for the predetermined period are used as a control group. The applied group and the control group undergo substantially the same abiotic stress for substantially the same period. When the ratio of lively individual plants (without withering, suffering from disease, or weakening) in the applied group is statistically significantly higher than the ratio of lively individual plants in the control group, the functional filamentous fungus is specified as having a resistance enhancing function for the growing plant.

The functional filamentous fungus can be specified as having a biome modification function in the manner described below. More specifically, the plant growing composite containing the functional filamentous fungus is applied to test soil (e.g., about 30 to 80 ml, or 50 ml in some embodiments, of the plant growing composite is applied to about 200 ml of test soil). Amplicon sequence analysis is performed on the microbiome in the test soil before the plant growing composite is applied and a predetermined period (e.g., about one to three weeks, or about two weeks in some embodiments) after the plant growing composite is applied. When the difference in fungi community constitution at the genus level before and after the plant growing composite is applied is greater than or equal to a predetermined reference value (hereafter, the value may be referred to as a biome modification reference value) in beta diversity in Bray-Curtis dissimilarity, the functional filamentous fungus is specified as having the biome modification function. For example, the amplicon sequence analysis may use a primer that targets at least a part of an internal transcribed spacer (ITS) region of the fungi. For example, the biome modification reference value may be 0.3, 0.35, 0.4, or 0.45.

The functional filamentous fungus can live in symbiosis with a growing plant. Symbiosis includes, in addition to physical symbiosis involving invasion or fusion of cells of the fungus into or with the plant body, chemical symbiosis involving exchanges of substances with plants. In addition to direct symbiosis with the plant, symbiosis also includes indirect symbiosis with the plant through another germ (a fungus, a bacterium, or an archaebacterium, rather than a filamentous fungus). The functional filamentous fungus may be, for example, a rhizosphere (soil) fungus that can live in symbiosis with a plant in the rhizosphere of the growing plant.

The functional filamentous fungus may be any nonmycorrhizal filamentous fungus in any order, family, genus, or species. Examples of the order to which the functional filamentous fungus belongs include, but are not limited to, Pleosporales, Cladosporiales, Helotiales, Hypocreales, Boletales, Mortierellales, Venturiales, Malasseziales, Chaetothyriales, Dothideales, Eurotiales, Magnaporthales, Adinetida, Mucorales, Xylariales, Cantharellales, Polyporales, and Glomerellales.

Examples of the family to which the functional filamentous fungus belongs include, but are not limited to, Didymellaceae, Cladosporiaceae, Hypocreaceae, Astraeaceae, Hyaloscyphaceae, Mortierellaceae, Venturiaceae, Malasseziaceae, Herpotrichiellaceae, Mollisiaceae, Aspergillaceae, Didymosphaeriaceae, Pseudeurotiaceae, Pyriculariaceae, Pleosporaceae, Adinetidae, Bionectriaceae, Mucoraceae, Apiosporaceae, Ceratobasidiaceae, Hamatocanthoscyphaceae, Morosphaeriaceae, Fomitopsidaceae, Glomerellaceae, Ploettnerulaceae, Vibrisseaceae, Hyphodiscaceae, and Nectriaceae.

Examples of the genus to which the functional filamentous fungus belongs include, but are not limited to, Cladosporium, Trichoderma, Astraeus, Hyaloscypha, Leptodophora, Malassezia, Cladophialophora, Mortierella, Phialocephala, Penicillium, Pseudeurotium, Linnemannia, Pyricularia, Curvularia, Adineta, Clonostachys, Mucor, Nigrospora, Rhizoctonia, Gremmenia, Acrocalymma, Fomitopsis, Colletotrichum, Cadophora, Phialocephala, Meliniomyces, Glutinomyces, and Fusarium.

The plant growing composite may contain one functional filamentous fungus alone or two or more functional filamentous fungi. When the plant growing composite contains two or more functional filamentous fungi, the multiple functional filamentous fungi may belong to the same order or two or more different orders. The multiple functional filamentous fungi may belong to the same family or two or more different families. The multiple functional filamentous fungi may belong to the same genus or two or more different genera. The multiple functional filamentous fungi may have the same or similar functions or different functions.

In some embodiments, the functional filamentous fungus corresponds to a microbial pesticide. In some embodiments, the functional filamentous fungus corresponds to a biostimulant that enhances resistance of plants against the biological and abiotic environments or adjusts the biological and abiotic environments surrounding the plants.

The substrate included in the plant growing composite is in the liquid state at normal temperature and may have any composition. In some embodiments, the substrate is a liquid containing water as a main content.

The substrate may contain saccharides. This may efficiently enhance the ratio of a mycelium as described below; and may maintain the mycelium in the functional filamentous fungus contained in the plant growing composite in a highly active (lively) state. Any saccharide may be contained. Examples of saccharides include, but are not limited to, monosaccharide, disaccharide, and oligosaccharide. Examples of saccharides include, but are not limited to, sucrose, glucose, galactose, fructose, lactose, and trehalose. The substrate may contain one saccharide alone or two or more saccharides.

The amount of saccharides contained in the substrate is 1 g/L or more in some embodiments, 3 g/L or more in some embodiments, 5 g/L or more in some embodiments, 7 g/L or more in some embodiments, and 10 g/L or more in some embodiments. The amount of saccharides contained in the substrate is 50 g/L or less in some embodiments, 30 g/L or less in some embodiments, 20 g/L or less in some embodiments. When the saccharides contained in the substrate have a concentration lower than or equal to a specific concentration, the activity of the functional filamentous fungus may rather be enhanced, and the cost for the plant growing composite may be lowered.

The saccharides can be quantified by, for example, analysis such as high performance liquid chromatography (HPLC), a phenol-sulfuric acid method, liquid chromatography-mass spectrometry (LC-MS), or gas chromatography-mass spectrometry (GC-MS). Sucrose can be quantified by, for example, resolving sucrose into fructose and glucose using invertase and by calculating the fructose concentration by colorimetry using fructose assay reagent. The same applies hereafter.

The substrate in the plant growing composite may contain at least one of amino acid, a peptide, or a protein (hereafter may be referred to as an amino acid-based substance). This may facilitate maintaining the functional filamentous fungus contained in the plant growing composite in a more highly active state. The amount of the amino acid-based substance contained in the substrate is 0.5 g/L or more in some embodiments, 1 g/L or more in some embodiments, and 3 g/L or more in some embodiments. The amount of the amino acid-based substance contained in the substrate is 10 g/L or less in some embodiments.

In some embodiments, the mycelium contained in the plant growing composite is derived from a culture obtained by culturing the functional filamentous fungus in a liquid medium under aerobic conditions, as described later in detail. In some embodiments, at least a part of the substrate is derived from the liquid medium.

The species of growing plants are not limited. Examples of growing plants include, but are not limited to, angiosperm (broadleaf tree or herbaceous angiosperms), gymnosperm (conifer or herbaceous gymnosperm), pteridophyte, and bryophyte.

Examples of broadleaf trees used as the growing plants include, but are not limited to, Alnus pendula, Alnus firma, Alnus sieboldiana, Alnus firma f. hirtella, Quercus spp., Quercus mongolica var. grosseserrata, Japanese white birch, Fagus crenata, Quercus acutissima, Zelkova serrata, Fraxinus mandshurica, Aesculus turbinata, Paulownia tomentosa, Castanea crenata, elm, Acer (maple), Cercidiphyllum japonicum, Fraxinus spaethiana, Morus bombycis, Castanopsis cuspidata, Cinnamomum camphora, Acacia, Machilus thunbergii, Betula grossa, Ostrya japonica, Juglans, Quercus (oak), Prunus (cherry), Prunus persica (peach), Prunus mume (Japanese plum tree), Eriobotrya japonica, Prunus armeniaca (apricot), Malus pumila (apple), Pyrus spp. (pear), Vitis (grape), Citrus, Camellia japonica, Theobroma cacao, Persea americana, lauan, Delbergia nigra, Pterocarpus santalinus, Chaenomeles sinensis, Diospyros ebenum, walnut, Tectona grandis, rubber tree (such as Hevea brasiliensis), falcataria, hickory, cherry, oak, hackberry, White Ash, Populus nigra var. italica, maple, Swietenia mahagoni, Beech, birch, palm, and Coffea.

Examples of herbaceous angiosperms used as the growing plants include, but are not limited to, Gramineae (such as Oryza sativa, barley, wheat, corn, and Setaria italica), Rosaceae (such as strawberry, raspberry, and Rubus buergeri), Amaryllidaceae (such as Welsh onion, onion, Chinese chive, and garlic), Solanaceae (such as eggplant, tomato, sweet pepper, Paprika, and potato), Cucurbitaceae (such as cucumber, oriental pickling melon, watermelon, melon, pumpkin, and zucchini), Compositae (such as lettuce, garland chrysanthemum, burdock, and butterbur), Cruciferae (such as cabbage, broccoli, Chinese cabbage, and Raphanus sativus var. raphanistroides), Umbelliferae (such as carrot and celery), Malvaceae (such as okra), Chenopodiaceae (such as spinach), Liliaceae (such as Asparagus officinalis), bean, palm, Musa basjoo, knotweed, Calystegia japonica, Colocasia antiquorum var. esculenta, Zingiber officinale, and Dioscoreaceae.

Examples of conifers used as the growing plants include, but are not limited to, Japanese cedar, pine, Japanese cypress, arborvitae, Tsuga sieboldii, momi fir, Chamaecyparis pisifera, Japanese yew; Japanese torreya, maidenhair tree, Douglas fir peeler, redwood, pine, larch, and cycad.

Examples of pteridophyte used as the growing plants include, but are not limited to, bracken, royal fern, horse tail, and Gleichenia japonica.

### 2. Method for Manufacturing Plant Growing Composite

A method for manufacturing the plant growing composite is described in detail. In some embodiments, the method for manufacturing the plant growing composite includes a planting site specifying process, a filamentous fungus specifying process, and a culture process. In some embodiments, the method for manufacturing the plant growing composite may further include a filamentous fungus collecting process. In some embodiments, the culture process may be a liquid culture process using a liquid medium. In some embodiments, the method for manufacturing the plant growing composite may further include a culture liquid storing process.

### 2.1 Planting Site Specifying Process

The planting site specifying process is to specify the planting site at which the growing plant as a growing target is planted. The planting site is any piece of specific land with a specific area with any size. Examples of the planting site include, but are not limited to, a state, a district, a prefecture, a municipality, a region, a zone, an afforested area, and a field. In some embodiments, the planting site is an area (such as a zone, an afforested area, or a field) collectively managed in a business activity of, for example, agriculture and forestry or green space creation.

### 2.2 Filamentous Fungus Collecting Process

The filamentous fungus collecting process is to collect nonmycorrhizal filamentous fungus candidates for the functional filamentous fungus from the environment. More specifically, a collection sample for collecting the filamentous fungus candidates is first collected (hereafter, the collection samples may simply be referred to as samples). Examples of collection samples include soil and a plant body slice of a plant that inhabits the environment. Subsequently, the filamentous fungus contained in the collection samples is isolated and cultured on a solid medium (such as a flat medium or a slant medium: the same applies hereafter.) The isolated filamentous fungus is stored on the solid medium as a filamentous fungus candidate (hereafter, the filamentous fungus candidate or the functional filamentous fungus stored in the isolate state may be referred to as an inoculum). The plant body slice used as the collection sample may be sliced from any portion of the origin plant. Examples of the plant body slice include, but are not limited to, the slices of a root, a leaf, a stem, fruit, and a flower.

The filamentous fungus collecting process and the planting site specifying process may be performed in any order. In some embodiments, the planting site specifying process is performed before the filamentous fungus collecting process. In this case, in the filamentous fungus collecting process, the collection samples can be collected from the planting site specified in the planting site specifying process or its neighborhood. This allows use of the filamentous fungus inhabiting the planting site of the growing plant or its neighborhood as the functional filamentous fungus contained in the plant growing composite, thus reducing artificial diffusion of gene resources occurring when the plant growing composite is applied to the growing plant. This additionally enhances the compatibility between the growing plant and the functional filamentous fungus, possibly allowing the functional filamentous fungus to function more effectively.

In this example, the neighborhood of the planting site is typically a region continuous with the planting site. The planting site and its neighborhood may be or may not be continuous and may be separated by another region. The neighborhood of the planting site may also be, for example, within a 500-km radius of the planting site of the growing plant. In some embodiments, the neighborhood is within a 300-km radius of the planting site of the growing plant. In some embodiments, the neighborhood is within a 100-km radius of the planting site of the growing plant. In some embodiments, the neighborhood is within a 50-km radius of the planting site of the growing plant. In some embodiments, the neighborhood is within a 30-km radius of the planting site of the growing plant. In at least one embodiment, the neighborhood is within a 10-km radius of the planting site of the growing plant.

In some embodiments, the collection samples can be obtained from a region having, for example, the same climate conditions as the planting site or a region where the classification of vegetation (hereafter may be referred to as potential natural vegetation) expected to occur with no human intervention is the same as that of the planting site. Examples of classifications of potential natural vegetation include, but are not limited to, alpine vegetation, evergreen coniferous forest, boreal coniferous broadleaf mixed forest, deciduous broadleaf forest, woods of momi fir and Tsuga sieboldii, and evergreen broadleaf forest.

In some embodiments, the collection samples can be collected from the natural environment or the secondary natural environment. In the natural environment or the secondary natural environment, a natural ecosystem typically occurring without human intervention has higher diversity in vegetation or soil biomes than, for example, an artificially maintained field. Thus, collection samples obtained in the natural environment or the secondary natural environment allow collection of diverse filamentous fungus candidates. This also increases the likelihood of the collected filamentous fungus candidates living in symbiosis with diverse plants. For the same reason, in some embodiments, the collection samples can be collected from the places other than the artificially maintained field. Examples of the natural environment include, but are not limited to, primeval forest, natural woods, and natural grassland. Examples of the secondary natural environment include, but are not limited to, an afforested area or its neighborhood grassland, grassland in a seminatural area, grassland around a field, dirt road or its neighborhood grassland, unoccupied land or its neighborhood grassland, abandoned farmland, abandoned forest, and weed-tree forest.

In some embodiments, the planting site specifying process is performed after the filamentous fungus collecting process. In this case, a filamentous fungus candidate collected from the planting site specified in the planting site specifying process or its neighborhood is selected from the filamentous fungus candidates isolated and stored in the filamentous fungus collecting process. The selected filamentous fungus candidate can be used to perform the filamentous fungus specifying process described later. This reduces, as described above, artificial diffusion of gene resources and can possibly enhance the compatibility between the growing plant and the functional filamentous fungus.

The origin plant may be in any specific species. The origin plant may be a plant of an indigenous species (a plant not designated as an invasive alien species). This may further enhance the compatibility between the growing plant and the functional filamentous fungus. The origin plant may typically be a vascular plant. The origin plant may be, for example, the same plant as the plant described as the example of the growing plant. The growing plant and the origin plant may be the same or different. The functional filamentous fungus collected from an arboreous plant as an origin plant may be applied to an herbaceous plant, or the functional filamentous fungus collected from an herbaceous plant as an origin plant may be applied to an arboreous plant.

The solid medium used to isolate or store the filamentous fungus candidate may have any specific composition. Although the solid medium is typically an agar medium, a medium solidified by another gelling agent (such as gelatin) may be used. Examples of the solid medium include a potato dextrose agar medium (PDA medium), a Modified Melin-Norkrans medium (MMN medium), an oatmeal agar medium, a potato sucrose agar medium (PSA agar medium), a potato carrot agar medium, a malt extract agar medium, a Czapek-Dox agar medium, a Czapek yeast extract agar medium, a MY20 agar medium, a Sabouraud's dextrose agar medium, a 1% yeast extract added Sabouraud's agar medium (SDY agar medium), and a reference agar medium. The solid medium described in other portions herein may use the same medium. In the filamentous fungus collecting process in some embodiments, a PDA medium is used.

### 2.3 Filamentous Fungus Specifying Process

The filamentous fungus specifying process is to specify, among the filamentous fungus candidates for the functional filamentous fungus, the filamentous fungus used as the functional filamentous fungus. In some embodiments, the filamentous fungus candidates are collected in the filamentous fungus collecting process. In some embodiments, the filamentous fungus candidates are deposited microorganism resources or commercially available filamentous fungi. In some embodiments, the planting site specifying process is performed before the filamentous fungus specifying process. The filamentous fungus specifying process is performed using the filamentous fungus candidates collected from the planting site specified in the planting site specifying process or its neighborhood. The filamentous fungus specifying process in some embodiments includes an analysis reference specifying process and an experiment reference specifying process. For one species of growing plants, one filamentous fungus candidate alone or two or more filamentous fungus candidates may be prepared.

The analysis reference specifying process is to narrow down the filamentous fungus candidates based on the soil microbiome analysis. The soil microbiome analysis can be performed by, for example, environment deoxyribonucleic acid (DNA) analysis (amplicon sequence analysis). This provides statistical information about the constitution or function of the fungi in the soil microbiome. With such information, the filamentous fungus candidates can be narrowed down without, for example, experiments, enhancing the efficiency of specifying the functional filamentous fungus.

In some embodiments, the analysis reference specifying process includes analyzing the soil microbiome at the place from which the filamentous fungus candidates are collected (the planting site of the growing plant or its neighborhood in some embodiments). In some embodiments, the analysis reference specifying process includes analyzing the soil microbiome at the planting site of the growing plant. The analysis reference specifying process may include analyzing the soil microbiome at both the place from which the filamentous fungus candidates are collected and the planting site of the growing plant.

The experiment reference specifying process is to specify the functional filamentous fungus based on the results of experiments. For example, to determine a functional filamentous fungus having the growth promotion function, a plant growing composite containing a single culture of a filamentous fungus candidate is manufactured and actually applied to the growing plant with, for example, a method described above in 1. Summarization of Plant Growing Composite. When specified as having the growth promotion function, the filamentous fungus candidate can be used as the functional filamentous fungus. Similarly, to determine, for example, a functional filamentous fungus having the protection function, a functional filamentous fungus having the diversity increase function, a functional filamentous fungus having the resistance enhancing function, or a functional filamentous fungus having the biome modification function, each filamentous fungus candidate can be specified as having or not having an intended function with the method described above in 1. Summarization of Plant Growing Composite. When specified as having the function, the filamentous fungus candidate can be used as the functional filamentous fungus. In some embodiments, the experiment reference specifying process is performed using the filamentous fungus candidates narrowed down in the analysis reference specifying process.

### 2.4 Liquid Culture Process

The liquid culture process is to culture the functional filamentous fungus specified in the filamentous fungus specifying process in a liquid medium. More specifically, the functional filamentous fungus isolated and stored on the solid medium is scraped off with, for example, a platinum loop and inoculated into the liquid medium, or the solid medium is cut off and the cut-off piece is placed into the liquid medium. The functional filamentous fungus is then cultured under aerobic conditions.

Culturing under aerobic conditions can be performed by shaking culture or stirring culture. The shaking culture can be performed with, for example, a shaker and a shakable container such as a test tube or a flask. The stirring culture can be performed with a spinner flask and a stirrer, a jar fermenter, or a culture tank. The amount of dissolved oxygen in the medium used for culturing in the liquid culture process is 1 to 10 mg/L inclusive in some embodiments, 2 to 10 mg/L inclusive in some embodiments, and 4 to 10 mg/L inclusive in some embodiments. In some embodiments, the culture medium remaining after the liquid culture process can be provided as the plant growing composite.

The liquid medium used in the liquid culture process is normally sterilized (by, for example, autoclave sterilization or filter sterilization). The liquid medium is normally in the liquid state mainly containing water.

The specific composition of the liquid medium is not limited. The liquid medium may contain a carbon source. Examples of the carbon source include, but are not limited to, a saccharide, plant residues, starch, cellulose, plant extracts, sugar alcohol (such as glycerol), and an organic acid. Examples of the saccharide include, but are not limited to, sucrose, glucose, galactose, fructose, lactose, trehalose, and oligosaccharide. Examples of the plant residues include, but are not limited to, rice bran, rice husks, bark, sawdust, straws, vegetable waste, soybean cake, sake lees, coffee grounds, draff, and tea waste. Examples of the plant extracts include, but are not limited to, extracts of vegetables (such as potato, sweet potato, and carrot), malt extract, and refinery molasses. Examples of the organic acid include, but are not limited to, a fumaric acid, a citric acid, and a pyruvic acid. One carbon source alone or two or more carbon sources may be added to the liquid medium. In some embodiments, the liquid medium contains a saccharide and plant residues as carbon sources. Such a liquid medium is less costly, possibly allowing growing of the mycelium more efficiently.

The total amount of the carbon sources added to the liquid medium is 1 g/L or more in some embodiments, 5 g/L or more in some embodiments, 10 g/L or more in some embodiments, 15 g/L or more in some embodiments, and 20 g/L or more in some embodiments. The amount of the carbon sources added to the liquid medium is 100 g/L or less in some embodiments, 80 g/L or less in some embodiments, 60 g/L or less in some embodiments, and 40 g/L or less in some embodiments.

For the liquid medium containing a saccharide and plant residues, the amount of the saccharide added to the liquid medium is 1 to 100 g/L inclusive in some embodiments, 5 to 50 g/L inclusive in some embodiments, and 10 to 30 g/L inclusive in some embodiments. The amount of the plant residues added to the liquid medium is 1 to 100 g/L inclusive in some embodiments, 10 to 70 g/L inclusive in some embodiments, and 20 to 50 g/L inclusive in some embodiments.

The liquid medium may contain a nitrogen source. Examples of the nitrogen source include, but are not limited to, natural organic nitrogen sources such as dry yeast, a yeast extract, a malt extract, peptone, triptone, a casamino acid, a meat extract, soybean flour, corn steep liquor, and cottonseed flour, and amino acids. Examples of the dry yeast include, but are not limited to, beer yeast, wine yeast, sake yeast, shochu yeast, and baker's yeast. One nitrogen source alone or two or more nitrogen sources may be added to the liquid medium. The amount of the nitrogen source added to the liquid medium is 1 g/L or more in some embodiments, 3 g/L or more in some embodiments, and 5 g/L or more in some embodiments. The amount of the nitrogen source added to the liquid medium is 50 g/L or less in some embodiments, 30 g/L or less in some embodiments, and 10 g/L or less in some embodiments.

The liquid medium may contain organic salt or inorganic salt. Examples of the organic salt or the inorganic salt include, but are not limited to, phosphates, sulfates, chloride salts, acetates, and carbonates of magnesium, sodium, potassium, iron, manganese, cobalt, and zinc. For example, thiamine may be added to the liquid medium as one of the vitamins. The liquid medium may contain one species or two or more species of organic salt, inorganic salt, or vitamins. The amount of organic salt, inorganic salt, or vitamins added to the liquid medium is 0.01 g/L or more in some embodiments and 0.5 g/L or more in some embodiments. The amount of organic salt, inorganic salt, or vitamins added to the liquid medium is 10 g/L or less in some embodiments and 5 g/L or less in some embodiments.

The carbon to nitrogen ratio (C/N ratio) of the liquid medium at the start of the liquid culture is 1.5 or higher in some embodiments, 3 or higher in some embodiments, and 5 or higher in some embodiments. The C/N ratio of the liquid medium is 30 or lower in some embodiments, 20 or lower in some embodiments, and 15 or lower in some embodiments. The C/N ratio may be calculated by dividing the entire carbon content (%) contained in the liquid medium by the entire nitrogen content (%). The entire carbon content (%) and the entire nitrogen content (%) may be measured using an elementary analyzer such as a carbon hydrogen nitrogen (CHN) coder. In another embodiment, the entire carbon content (%) may be an approximate value of the product of the organic matter content (%) calculated with an ignition loss method by 0.47 (With the ignition loss method, 2 g of the materials in the liquid medium other than water fully mixed at the ratio of manufacture of the liquid medium is measured, and the mixture is placed in a crucible and heated at 580° C. for two or more hours for incineration. The residues in the crucible after the incineration are measured as weight W₁ to calculate the organic matter content (%)=W₁/2×100). The entire nitrogen content (%) may instead be determined by Kjeldahl digestion (with a distillation method or an ion electrode method).

Examples of the liquid medium include a potato dextrose liquid medium, a Sabouraud's liquid medium, and an oatmeal medium.

In some embodiments, the liquid medium contains, as the carbon sources, rice bran and sucrose and contains, as a nitrogen source, beer yeast (hereafter, this liquid medium may be referred to as an YBS liquid medium). The YBS liquid medium is further examined in Examined Example 1 described later. The amount of rice bran added to the YBS liquid medium is 1 to 100 g/L inclusive in some embodiments, 10 to 70 g/L inclusive in some embodiments, and 20 to 50 g/L inclusive in some embodiments. The amount of sucrose added to the YBS liquid medium is 1 to 100 g/L inclusive in some embodiments, 5 to 50 g/L inclusive in some embodiments, and 10 to 30 g/L inclusive in some embodiments. The amount of beer yeast added to the YBS liquid medium is 1 to 50 g/L inclusive in some embodiments, 3 to 30 g/L inclusive in some embodiments, and 5 to 10 g/L inclusive in some embodiments.

The culture temperature in the liquid culture process is not limited to any temperature value. The culture temperature is 10 to 35° C. inclusive in some embodiments and to 30° C. inclusive in some embodiments. The pH of the liquid medium is 4 to 11 inclusive in some embodiments and about 5 to 7 inclusive in some embodiments.

The culture time in the liquid culture process is not limited either. The culture time is one day (24 hours) to ten days in some embodiments and two to five days in some embodiments. The culture time in the liquid culture process may be determined based on the absorbance or the turbidity of the culture medium. For example, the culturing may be performed until the turbidity of the culture medium or a lump of mycelia is clearly observed visually. The culture time can be determined based on the absorbance of the culture medium. More specifically, for example, a part of the culture medium in culturing is sampled and dispersed in the same manner as in a dispersion process (described later) to prepare a mycelia suspension. When the absorbance of the mycelia suspension at a predetermined wavelength (such as 600 nm, 660 nm, or 700 nm) reaches a predetermined value (such as 0.5, 1.0, 2.0, or 3.0) or greater, culturing may be ended.

In some embodiments, one functional filamentous fungus is simply added to a batch of the liquid medium for liquid culture in the liquid culture process. This can possibly allow the intended functional filamentous fungus to be grown efficiently. In another embodiment, two or more functional filamentous fungi may be added to a batch of the liquid medium. More specifically, two or more functional filamentous fungi can be cocultured in a batch of the liquid medium.

### 2.5 Culture Liquid Storing Process

The culture liquid storing process is to store the culture medium used in the liquid culture process. In the culture liquid storing process, the culture medium is normally stored still at a lower temperature than the culture temperature in the liquid culture process. The lower temperature reduces the growth of the functional filamentous fungus contained in the culture medium to reduce the consumption of oxygen, possibly maintaining the lively state of the functional filamentous fungus stored still. In some embodiments, the culture medium used in the culture liquid storing process may be provided as the plant growing composite.

The storing temperature in the culture liquid storing process is 0 to 25° C. inclusive in some embodiments, 4 to 15° C. inclusive in some embodiments, and 4 to 10° C. inclusive in at least one embodiment. The storing period is shorter than or equal to one month in some embodiments.

The culture medium used in the liquid culture process may be used in the culture liquid storing process after cutting and dispersing a mycelium of the functional filamentous fungus contained in the culture medium in the same manner as in the dispersion process described below: In some embodiments, the culture medium used in the liquid culture process is directly (without dispersing a mycelium of the functional filamentous fungus) used in the culture liquid storing process. This may possibly allow the mycelium of the functional filamentous fungus to be stored in a livelier state.

Before, during, or after the culture liquid storing process, an additive may be added to the culture medium. Any additive may be added. Examples of the additive include, but are not limited to, an acid, a base, a saccharide, an amino acid, a peptide, a phosphorus compound, a nitrogen compound, and a potassium compound. One additive alone or two or more additives may be added. The additive may be one of various materials used for manufacturing the liquid medium. The additive may be added once or twice or more times.

The plant growing composite manufactured as above is derived from the liquid culture of the functional filamentous fungus, with a mycelium of the functional filamentous fungus contained in the liquid substrate. A part of or the entire substrate is derived from the liquid medium used in the liquid culture process. The percentage of the portion of the substrate in the plant growing composite derived from the liquid medium is 50% or higher in some embodiments, 70% or higher in some embodiments, 90% or higher in some embodiments, and about 100% in some embodiments. Using the liquid medium as the substrate reduces direct contact of the functional filamentous fungus with air, possibly maintaining a high ratio of a mycelium of the functional filamentous fungus or maintaining the functional filamentous fungus at a higher level of activity.

### 4. Method for Growing Plant

A method for growing the growing plant using the plant growing composite is described in detail below: The plant growing composite can be applied to the growing plant by being placed into contact with the terrestrial part or the subterranean part of the plant body of the growing plant or the seed of the growing plant. The plant growing composite can also be applied to the growing plant by being soaked into a support that supports the root of the growing plant. The plant growing composite can further be applied to the growing plant by being mixed with a growing solution for hydroponics or by being used as the growing solution for hydroponics. The plant growing composite may be soaked into the support on which the growing plant has been planted or into the support on which the growing plant is to be planted.

In some embodiments, before the plant growing composite is applied, the dispersion process of cutting and dispersing (suspending) a mycelium of the functional filamentous fungus contained in the plant growing composite is performed. The dispersion process can be performed using, for example, a blender, a mixer, a mill, or a homogenizer. When a blender or a mixer is used, the capacity of the blender or the mixture is 0 to 20 L in some embodiments and 0 to 5 L in some embodiments. The number of revolutions of the mixer is 5000 to 50000 revolutions/minute inclusive in some embodiments, and 10000 to 30000 revolutions/minute inclusive in some embodiments. The operation time of the mixer is about ten seconds to two minutes in some embodiments. In some embodiments, the culture medium used in the dispersion process may be provided as the plant growing composite (specifically, the dispersion process may be included in the method for manufacturing the plant growing composite).

In some embodiments, the plant growing composite is processed in a processing process before the plant growing composite is applied. Examples of the processing performed in the processing process include, but are not limited to, diluting the plant growing composite, concentrating the plant growing composite, mixing the plant growing composite with another plant growing composite, and adding an additive to the plant growing composite. The processing process may include one type of processing alone or two or more types of processing. In some embodiments, the culture medium used in the processing process may be provided as the plant growing composite (specifically, the processing process may be included in the method for manufacturing the plant growing composite).

In the processing process, the plant growing composite can be diluted using water, a liquid medium, or another liquid as a dilute solution. The dilution factor of the plant growing composite may be, but is not limited to, 2-fold or higher in some embodiments, 3-fold or higher in some embodiments, and 5-fold or higher in some embodiments. The dilution factor of the plant growing composite may be 1000-fold or lower in some embodiments, 100-fold or lower in some embodiments, and 50-fold or lower in some embodiments. The plant growing composite may be concentrated by, for example, filtration or centrifugation.

In the processing process, mixing of the plant growing composite may be mixing two or more culture media including different species of functional filamentous fungi. This provides the plant growing composite containing two or more species of the functional filamentous fungi, reducing time and effort in applying plant growing composites. The multiple species of functional filamentous fungi to be mixed are a combination of species that normally do not inhibit the growth or increase of the other.

In the processing process, any additive may be added. Examples of the additive include, but are not limited to, an acid, a base, a saccharide, an amino acid, a peptide, a phosphorus compound, a nitrogen compound, and a potassium compound. The additive may also be one of various materials used to manufacture the liquid medium. One additive alone or two or more additives may be added. The dispersion process and the processing process may be performed in any order, but in some embodiments, the dispersion process is performed first. The processing process may be performed multiple times.

The plant growing composite may be applied at any time during the growth of the growing plant (except for seeding period). In some embodiments in which the plant growing composite contains the functional filamentous fungus having at least one of the protection function, the diversity increase function, the resistance enhancing function, or the biome modification function, the composite is applied to the seedling of the growing plant or applied after the growing plant is planted. This may enhance at least one of the protection function or the diversity increase function. In some embodiments in which the plant growing composite contains the functional filamentous fungus having the growth promotion function, the composite is applied to the seed of the seedling of the growing plant. This may enhance a growth promotion effect. The plant growing composite may be applied to a growing plant once or twice or more.

In some embodiments, the plant growing composite is used to grow commercial use growing plants. In other words, the plant growing composite is provided for commercial use. The commercial use includes, but are not limited to, use in agriculture, forestry, green space or land creation, and construction.

In one or more embodiments of the disclosure, a filamentous fungus having a function beneficial to maintaining the growth or the growing environment of a plant as intended is isolated as an inoculum and cultured in a liquid medium. A liquid formulation (plant growing composite) containing a mycelium derived from the inoculum is prepared to introduce the liquid formulation into a plant cultivation system (in other words, a plant body at the rhizosphere or the terrestrial part). The plant cultivation system herein indicates the area where the plants are grown, or more specifically, the rhizosphere and the terrestrial part of the plant. The rhizosphere is a subterranean part including the plant root and the material (hereafter may be referred to as a support base) such as soil or artificial soil containing the plant root. Introducing the liquid formulation into the plant cultivation system refers to wetting the plant body (terrestrial part) or the rhizosphere (subterranean part) with the liquid formulation by applying, sprinkling, or impregnating the liquid formulation to the plant body (terrestrial part) in the plant cultivation system or the root and its surrounding (rhizosphere).

The function beneficial to the growth or growing environment of a plant as intended may be herein referred to as an adjusting function. In particular, a function beneficial to the growth of plants may be referred to as a contributing function. The function of adjusting the plant growing environment may be referred to as an environment control function. In one or more embodiments of the disclosure, a filamentous fungus having the adjusting function can be specified as a contributing-function filamentous fungus that improves the constitution or the function of a biome in the plant cultivation system, or particularly, a biome at the rhizosphere of a plant, to a constitution or a function beneficial to plant growth. A filamentous fungus having the adjusting function can also be specified as an environment control filamentous fungus that can change the plant growing environment to artificially set conditions (e.g., reducing emission of the greenhouse gases, increasing biodiversity, or improving the physicochemistry of the support base).

Examples of the contributing-function filamentous fungus include, but are not limited to, fungi of Mortierellales genus as a growth promoting filamentous fungus that allows the plant to grow well. Examples of the protecting filamentous fungus include, but are not limited to, fungi of Trichoderma genus that can protect a plant against various plant disease fungi or pests. Examples of the environment control filamentous fungus include, as a greenhouse gas reduction filamentous fungus, fungi of Cadophora genus, fungi of Phialocephala genus, and fungi of Meliniomyces genus, but are not limited to these examples. The greenhouse gas reduction filamentous fungus reduces emission of greenhouse gases by improving the acclimation of the plant in high-temperature, dry, and high-carbon dioxide environments. Examples of another environment control filamentous fungus other than the greenhouse gas reduction filamentous fungus include, as a fungus having a diversity increase function, fungi of Cladophialophora genus and fungi of Glutinomyces genus that can live in symbiosis with various filamentous fungi including the contributing-function filamentous fungus, but are not limited to these examples.

In some embodiments, the plants located at the planting site at which the plants are grown or in its neighborhood (in some embodiments, within a radius of 100 to 300 km from the planting site in Japan, or within a radius of about 500 km from the planting site for a vast adjoining land in other countries) are analyzed, or the microbiomes at the rhizospheres of the plants are analyzed. The filamentous fungus having the above functions can be specified from symbiosis nonmycorrhizal filamentous fungi (symbiosis indigenous nonmycorrhizal filamentous fungi) constituting the microbiome and living in symbiosis with the plants. When the filamentous fungus is specified from the symbiosis indigenous nonmycorrhizal filamentous fungi, the nonmycorrhizal filamentous fungus used in one or more embodiments of the disclosure can be easily specified. The use of an indigenous filamentous fungus can avoid artificial diffusion of genetic resources. Additionally, an indigenous filamentous fungus is more compatible with various organisms living in the region than a nonindigenous filamentous fungus. Thus, using an indigenous filamentous fungus can expectedly enhance the set functions.

The filamentous fungi include a mycorrhizal filamentous fungus that forms a mycorrhiza (symbiont living with a plant in a special form) and a nonmycorrhizal filamentous fungus that does not form a mycorrhiza. The mycorrhizal fungi, which typically use a living host plant for growth (hereafter may be referred to as obligate symbiosis), can be artificially grown in symbiosis with the plant root, or on a special medium or with a special culture method. In contrast, nonmycorrhizal filamentous fungi expectedly have a symbiotic relationship with the plant by causing their mycelia to invade into the plant body without forming a mycorrhiza or by establishing close contact with the rhizosphere of the plant. Thus, the nonmycorrhizal filamentous fungi alone can be artificially and purely cultured (isolated) using a typical medium or animal or plant residues as a substrate without living in symbiosis with the plant root (hereafter referred to as isolate cultured fungi).

Isolate cultured-nonmycorrhizal filamentous fungi can use various animal or plant residues such as humus for plant cultivation materials as growth substrates and grow rapidly. Although nonmycorrhizal filamentous fungi extend mycelia and have active metabolism under appropriate environmental conditions, mycelia are more delicate than spores or conidia, which are dormant. The inventor has examined such filamentous fungi and successfully prepared the liquid formulation that provides an intended function and is easily handleable. More specifically, the inoculum obtained by isolating and culturing the filamentous fungus intended to be grown is inoculated to the liquid medium and shaken for culturing under aerobic conditions. This allows preparation of a liquid formulation containing extended mycelia. In some embodiments, the mycelia are introduced into the cultivation system in substantially homogeneously. In some embodiments, the mycelia are dispersed in the liquid to be substantially homogeneous in the liquid.

The liquid formulation may contain mycelia of two or more functional filamentous fungi. In this case, two or more culture media containing mycelia obtained by growing different inocula in separate liquid media are mixed to obtain the liquid formulation. A first functional filamentous fungus and a second functional filamentous fungus used in one or more embodiments of the disclosure may coexist. Coexisting indicates that each filamentous fungus does not invade or inhibit growth of the other. Such a combination is specified by, for example, coculturing candidates for a first filamentous fungus and a second filamentous fungus.

The liquid formulation may be introduced into the cultivation system by irrigating the rhizosphere of the plant with the liquid formation, by sprinkling the liquid formulation on the terrestrial part of the plant, or by soaking the rhizosphere of the plant in the liquid formulation. For example, the liquid formulation may be introduced into the cultivation system by using a plant cultivation device that includes a seedling growing container as an introducer to introduce the liquid formulation into the cultivation system and an agriculture or gardening container as a liquid retainer, which is referred to as a tub, a plastic tub, or a plastic container. The seedling growing container is filled with compost for growing a seedling, with the seed of a target plant sown on the compost. The agriculture or gardening container is sized to receive the seedling growing container for soaking. In another example, the liquid formulation may be introduced into the cultivation system by using a plant cultivation device, such as a watering pot, that includes a tank to hold the liquid formulation as a liquid holder and a nozzle to sprinkle the liquid in the tank as an introducer.

The technique according to one or more embodiments of the disclosure allows introduction of a filamentous fungus having a function beneficial to maintaining the growth or the growing environment of a plant as intended into the growing plant or the plant growing environment with a simple operation. For example, the technique according to one or more embodiments of the disclosure can shorten the period for growing a seedling taken before the plant is planted by introducing the filamentous fungus that promotes plant growth into the cultivation system to promote plant growth. The technique according to one or more embodiments of the disclosure can reduce disease by introducing the filamentous fungus having the protection function against plant disease fungi into the cultivation system. Additionally, a filamentous fungus that increases the biodiversity of the plant cultivation system, such as a nonmycorrhizal filamentous fungus friendly to the growing plant, may be gathered from the biome around the planting site to the plant seedling to increase the diversity of organisms at the roots of the plant seedling and improve the rooting of the planted plant seedling. The technique according to one or more embodiments of the disclosure can also reduce greenhouse gases emitted from the cultivation system by introducing, into the cultivation system, the filamentous fungus that improves the acclimation of the plant.

The technique according to one or more embodiments of the disclosure can provide easily manufacturable, low-priced, easily handleable plant cultivation materials. For the liquid formulation according to one or more embodiments of the disclosure, the attributes (functions expected from genetic information including genus, species, and genealogy) of microorganisms (nonmycorrhizal filamentous fungi) used as functional materials that improve the characteristics of organisms are specified. The liquid formulation can thus easily function as intended. For example, a filamentous fungus having a functional material specified from the filamentous fungi inhabiting the planting site or its neighborhood can easily produce its effect at the place of use, reducing artificial diffusion of genetic resources.

One embodiment of the disclosure is described below: First, nonmycorrhizal filamentous fungi that contributes to the growth promotion function for the growing plant (growth promotion fungus), the protection function against pathogenic fungi or environmental stress (protection fungus), the organism diversity increase function at the root (diversity increase fungus), and the greenhouse gas emission reduction function (greenhouse gas reduction fungus) are specified. The nonmycorrhizal filamentous fungus is a fungus having the protection function against disease fungi identified as constituents of the soil microbiome at the planting site of the growing plant. Identifying the pathogenic fungi constituting the soil microbiome at the planting site can limit the range of the protection fungi to facilitate specifying the nonmycorrhizal filamentous fungus. The nonmycorrhizal filamentous fungus with the diversity increase function is, for example, a fungus that gathers multiple microorganisms friendly to the growing plant identified from the soil microbiome at the planting site of the growing plant or in its neighborhood.

Any or all of the nonmycorrhizal filamentous fungi having the growth promotion function, the protection function, the diversity increase function, and the greenhouse gas reduction function may constitute the indigenous soil microbiome at the planting site or in its neighborhood. Examples of the method for specifying the microorganisms include specifying the microorganisms having an effect of growth promotion for a growing plant, protection, diversity increase, or greenhouse gas emission reduction through literature research or microorganism database search, performing analysis based on Toju, H. et al., Core Microbiomes for Sustainable Agroecosystems. Nature Plants 2018, 4, 247-257, and a testing an isolated strain of filamentous fungus contained in samples collected from the planting site or its neighborhood to obtain a filamentous fungus having an intended effect.

Isolate cultures of the nonmycorrhizal filamentous fungi with the growth promotion function, the protection function, the diversity increase function, and the greenhouse gas reduction function are used as inocula and inoculated into the culture substrate for microorganisms to grow the microorganisms. The inocula used are isolated from the soil at the planting site (agricultural or forest land) at which the growing plant is planted or in its neighborhood or from the vegetable tissue grown at the planting site or in its neighborhood and cultured. The nonmycorrhizal filamentous fungus that can be isolated and cultured may be artificially isolated and cultured alone using a typical medium (e.g., a PDA medium or an oatmeal medium) or animal or plant residues as a substrate without a symbiont (mycorrhiza) living with a plant root. Soil at the planting site or in its neighborhood also includes an artificial soil alternative to be used for the planting site that is a cultivation facility.

In some embodiments, one nonmycorrhizal filamentous fungus or a combination of two or more of nonmycorrhizal filamentous fungi with the growth promotion function, the protection function, the diversity increase function, and the greenhouse gas reduction function that can be isolated and cultured is specified for each growing plant. When the nonmycorrhizal filamentous fungus having the adjusting functions of the specified combination is introduced into the cultivation system of the growing plant as a pure or mixed liquid formulation, the nonmycorrhizal filamentous fungus induces symbiosis with the growing plant as appropriate for each stage of growing the growing plant. The growth promoting nonmycorrhizal filamentous fungus and the protecting nonmycorrhizal filamentous fungus may coexist as a combination.

The growth promotion fungus and the diversity increase fungus may be introduced into the cultivation system at any time during the early stage of the growth of the growing plant (during growing the seedling) at any place other than the planting site to cause the fungus to live in symbiosis with the growing plant. The protection fungus and the greenhouse gas reduction fungus may be introduced after the growth promoting filamentous fungus or the diversity increase filamentous fungus establishes the symbiotic relationship with the growing plant. For example, the protection fungus and the greenhouse gas reduction fungus may be introduced into the cultivation system at any time during the period after the growing plant is planted and before the plant starts being rooted in the soil. The liquid formulation can be introduced into the cultivation system to grow these nonmycorrhizal filamentous fungi at the rhizosphere or the leaf surfaces of the growing plant.

For example, the inocula cultured on, for example, solid media are grown in the liquid medium to be mycelia to prepare a liquid formulation containing the mycelia. This liquid formulation can be introduced into the cultivation system by being sprinkled on the roots of the growing plant (specifically, irrigating the roots with the liquid formation) or on the terrestrial part of the plant (such as the leaf surfaces) or by soaking a container holding the growing plant into the liquid formulation. The liquid medium for growing a mycelium from an inoculum may contain an organic residue as a nutrient for the nonmycorrhizal filamentous fungus and also contain a constituent that is absorbable as a nutrient by the growing plant. The processes from preparation of an inoculum to preparation of a liquid formulation are described below:

An isolate cultured nonmycorrhizal filamentous fungus of any of the growth promoting fungus, the protecting fungus, the diversity increase fungus, and the greenhouse gas reduction fungus is isolated using a microorganism culture medium and artificially grown alone, or purely cultured, to be used as an inoculum. More specifically, a sample (e.g., soil or a plant body collected from a planting site or its neighborhood) containing a nonmycorrhizal filamentous fungus specified as a growth promotion fungus, a protection fungus, a diversity increase fungus, or a greenhouse gas reduction fungus is cultured on a medium for culturing a filamentous fungus culture (e.g., a PDA medium), and the resulting fungal body is transplanted to a medium for isolation (a filamentous-fungi culture medium such as a PDA medium) to be purely cultured into an inoculum.

In one or more embodiments of the disclosure, the liquid formulation containing the mycelium described below can be prepared. The mycelium is obtained by isolating, on a microorganism culture medium, the isolate cultured nonmycorrhizal filamentous fungus with the growth promotion function, the protection function, the diversity increase function, or the greenhouse gas reduction function contained in the samples collected from the agricultural or forest land on which the growing plant is grown or its neighborhood. The cultured inoculum is grown in the liquid medium.

The nonmycorrhizal filamentous fungus that can be isolated and cultured can be grown using, as a substrate, organic residues serving as organic media such as vegetable tissue extracts (dregs), decomposition products of yeast cytoplasm, or animal gelatin. The organic media contains saccharides used for the growth of microorganisms such as dextrose. Such an organic medium is less expensive and allows easy access and handling. Thus, in some embodiments, the inoculum isolated from a sample and cultured is inoculated into the organic medium to grow the mycelia and obtain the grown mycelia.

The filamentous fungus with the growth promotion function may colonize the rhizosphere at the rooting of a plant seedling. In some embodiments, an inoculum of a growth-contributing filamentous fungus is inoculated into the liquid medium mainly containing a vegetable tissue extract, to which a saccharide is added as appropriate, to extend or grow the mycelium. The liquid containing the extended mycelium is injected into the compost for growing a plant or directly sprinkled on the plant seedling to infiltrate the liquid to the surroundings of the roots of the growing plant. This induces symbiotic living of the growth promoting filamentous with the growing plant.

The substrate (microorganism growing substrate) for growing the inoculum contains more nitrogen and phosphorus than the compost for growing a plant. The substrate for growing the microorganism is a liquid medium. The liquid medium may be, for example, a liquid containing a plant extract for culturing a nonmycorrhizal filamentous fungus (e.g., potato dextrose liquid medium) or may be a culture substrate for microorganism culturing experiment used to prepare an inoculum. In another example, the substrate for growing the microorganism may be an organic medium mainly containing a vegetable tissue extract, which is easily accessible and usable as a gardening liquid fertilizer. More specifically, an organic medium mainly containing plant residues such as malt or corn may be used. In another example, a dextrose source such as starch may be mixed. The liquid medium for growing the inoculum may contain nitrogen, phosphorus, or potassium.

The liquid medium may be sterilized before inoculated with an inoculum. In particular, a commercially available gardening liquid fertilizer may contain various microorganisms. The liquid medium may thus be sterilized to kill or inactivate microorganisms other than the inoculum before inoculated with a cultured inoculum. This allows the inoculum to be dominant in the growth substrate and to extend its mycelium. About 1 g of the cultured inoculum including an agar medium may be placed into 100 ml of the sterilized liquid medium in capacity ratio. A smaller amount of the inoculum increases the growing time taken before sufficient mycelia are obtained to colonize the growing plant, whereas a larger amount of the inoculum may exhaust nutrients in the liquid medium and inactivate the mycelia.

The liquid medium inoculated with the inoculum is cultured at a temperature (about normal temperature) appropriate for the growth of the nonmycorrhizal filamentous fungus to grow the mycelia, thus providing a liquid in which the mycelia of the microorganisms derived from the inoculum are dominant. The liquid culture of the inoculum may be conducted under aerobic conditions. For example, the liquid culture may be a shake culture using a shake culture device. The culturing may be continued until the mycelia derived from the inoculum grows to cause a suspension state in the liquid medium, with the mycelia gathering to be observable with the naked eyes. When, for example, the liquid medium inoculated with the inoculum is shaken and cultured, the mycelia may gather in a shape of Cladophora ball or as algae-like floating matter. The mycelia gathering to be observable with the naked eyes may be maintained in a dispersed state in the liquid medium by, for example, stirring. In some embodiments, the culture time is a time sufficient for the mycelia derived from the inoculum to be visible with the naked eyes.

The culture medium containing the mycelia derived from the inoculum grown in the liquid medium may be used as the liquid formulation without performing any process on the culture medium, may be used after being diluted, or may be used with addition of an additive or another liquid formulation. For example, when the inoculum is inoculated into a transparent liquid medium and cultured to obtain a suspension with the collection of mycelia in a shape of Cladophora ball or algae being dispersed, the liquid formulation obtained by diluting the suspension 2 to 10-fold may be introduced into the cultivation system.

The liquid formulation containing the mycelia resulting from growing the inoculum with the growth promotion function or the diversity increase function can be infiltrated around the roots of the growing plant seedling to allow the mycelium of the filamentous fungus contained in the liquid formulation including the liquid fertilizer for growing a plant to easily and physically colonize the plant roots. The material of the liquid fertilizer for growing a plant is not limited, but may contain organic matter such as plant residues to allow symbiosis microorganisms to extend the mycelia.

When the compost for growing a plant is irrigated with the liquid formulation containing mycelia, or the liquid formulation is sprinkled on the compost, about 30 to 80 ml of the liquid fertilizer can be applied to about 200 ml of the compost in capacity ratio. A smaller amount of the liquid fertilizer may cause insufficient colonization of the plant roots by the mycelia of the inoculum, whereas a larger amount of the liquid fertilizer may supply excess nutrients to the compost for growing a plant.

The compost into which the liquid formulation is to be infiltrated may already have the seedlings of the growing plant sown, germinated, or rooted. For example, the liquid formulation may be applied to the compost in which the growing plant has been rooted and is growing. When the liquid formulation is introduced into the rhizosphere of the growing plant with its roots extending, the mycelia of the filamentous fungi derived from the symbiosis microorganisms in the inoculum at the rhizosphere of the growing plant extend within several days to several weeks from the introduction of the liquid formulation. The extended mycelia colonize or invade the periphery or the inside of the root tissues of the growing plant, establishing a symbiotic relationship between the growing plant and microorganisms.

The seedlings of the growing plant are grown while colonized by the nonmycorrhizal filamentous fungus with the growth promotion function or the diversity increase function, and can be planted at the planting site for growing. For example, the seedlings are grown using a seedling growing container. The liquid formulation according to one or more embodiments of the disclosure is applied to allow the seedlings to live in symbiosis with the growth promoting filamentous fungus. This allows the seedlings to grow well in the early stage to be robust and grow quickly (specifically, be ready to be planted early). In another example, when the seedlings live in symbiosis with a diversity increase filamentous fungus, soil microbiome of symbiotic bacteria friendly to the growing plant may occur at the plant seedling rhizosphere before the seedlings are planted.

In addition to the nonmycorrhizal filamentous fungus with the growth promotion function or the diversity increase function, the symbiotic relationship between the nonmycorrhizal filamentous fungus with the protection function or the greenhouse gas reduction function and the growing plant can be artificially induced. The symbiotic relationship between the nonmycorrhizal filamentous fungus with the protection function or the greenhouse gas reduction function and the growing plant may be established after, for example, the nonmycorrhizal filamentous fungus with the growth promotion function and the growing plant are artificially caused to live in symbiosis with each other. In some embodiments, the symbiotic relationship may be established before and after the seedlings of the growing plant are planted at the planting site.

A nonmycorrhizal filamentous fungus with the protection function or the greenhouse gas reduction function and that can be isolated and cultured can be specified and isolated in the same manner as the nonmycorrhizal filamentous fungus with the growth promotion function. An inoculum of a nonmycorrhizal filamentous fungus with the protection function or the greenhouse gas reduction function can be prepared in the same manner as the nonmycorrhizal filamentous fungus with the growth promotion function. To promote the growth of the plant seedlings in the early stage, the nonmycorrhizal filamentous fungus with the growth promotion function is allowed to be in the rhizosphere when the growing plant is rooted. In contrast, the filamentous fungus with the protection function or the greenhouse gas reduction function is allowed to live in symbiosis with the plant seedlings after the early stage of the growth of the plant seedlings, or for example, when the plant seedlings are planted (about several days to several weeks before and after the planting). For example, the protecting filamentous fungus is allowed to live in symbiosis with the plant seedlings before a specific pathogenic fungus preventable by the filamentous fungus infects the planted plant seedlings to cause disease symptoms to appear.

The liquid formulation containing the mycelium of the nonmycorrhizal filamentous fungus with the protection function or the greenhouse gas reduction function can be prepared in the manner described above. The liquid formulation containing the mycelium of the filamentous fungus with the protection function or the greenhouse gas reduction function is directly infiltrated into the roots of growing plant seedling that is being grown. This induces symbiotic living of the filamentous fungus with the plant seedlings.

Rather than being introduced into the cultivation system as a liquid formulation, the nonmycorrhizal filamentous fungus with the growth promotion function or the diversity increase function may be mixed with the rooting compost with the method described in Japanese Patent Application No. 2021-146540 to live in symbiosis with the plant seedlings. More specifically, an inoculum obtained by isolating and culturing the nonmycorrhizal filamentous fungus with the growth promotion function or the diversity increase function is grown on a solid medium such as humus. The culture containing the mycelium is introduced into the rooting compost. The growing plant is then sown and rooted to grow into seedlings. The liquid formulation containing the my celium of the nonmycorrhizal filamentous fungus with the protection function or the greenhouse gas reduction function may be sprinkled on or impregnated into the obtained plant seedlings.

In some embodiments, the above liquid formulation is used at the planting site of the growing plant or in its neighborhood. The soil microorganisms or the plants grown at the planting site interact with the natural environment at the planting site or the physical, chemical, or biological environments of the soil. Indigenous plants or microorganisms adapted to the land can be used to reduce effects resulting from artificial diffusion of genetic resources.

In some embodiments, an agricultural or forest land is divided into areas with a predetermined measurements (in some embodiments, into about 200 km squares, or 100 km squares in Japan, or in some embodiments, into about 300 km to 500 km squares in countries having a vast agricultural or forest land, such as the U.S. or China). For management, combinations of a growing plant and an isolate cultured nonmycorrhizal filamentous fungus with the growth promotion function, the diversity increase function, the protection function, or the greenhouse gas reduction function can be listed for each divided area.

Implementation of the technique according to one or more embodiments of the disclosure includes specifying the filamentous fungus having an adjusting function to be introduced into the cultivation system by analyzing soil at the planting site or in its neighborhood or the microbiome of the plant, determining the method for using the liquid formulation containing a mycelium according to one or more embodiments of the disclosure based on the growth of a growing plant, and providing instructions or supports for plant cultivation to provide a plant cultivator with a plant cultivation method appropriate for the determined method for using the liquid formulation.

In some embodiments, a method for growing a plant is provided. The method includes specifying a contributing-function filamentous fungus having a function contributable to growth of a plant to be artificially grown, and applying a liquid formulation containing a mycelium of the contributing-function filamentous fungus to a terrestrial part of the plant or infiltrating the liquid formulation into a subterranean part of the plant. The contributing-function filamentous fungus is an indigenous nonmycorrhizal filamentous fungus to inhabit a planting site at which the plant is to be planted or a neighborhood of the planting site and to live in symbiosis with the plant without forming a mycorrhiza. The liquid formulation contains an inoculum grown in a liquid medium. The inoculum results from isolation and culturing of the contributing-function filamentous fungus. The liquid medium contains a growth substrate of the contributing-function filamentous fungus (hereafter, this embodiment may be referred to as Embodiment E1).

In Embodiment E1, the contributing-function filamentous fungus may be specified as a growth promoting filamentous fungus to promote the growth of the plant and a protecting filamentous fungus to protect the plant against a disease fungus. The liquid formulation may include a first liquid formulation and a second liquid formulation. The first liquid formulation may contain a mycelium of the growth promoting filamentous fungus, and the second liquid formulation may contain a mycelium of the protecting filamentous fungus. The liquid formulation may be a mixed agent containing mycelia of the growth promoting filamentous fungus and the protecting filamentous fungus (hereafter, this embodiment may be referred to as Embodiment E2).

In some embodiments, a method for artificially growing a plant using a liquid formulation is provided. The liquid formulation contains a nonmycorrhizal filamentous fungus grown in a liquid medium. The nonmycorrhizal filamentous fungus lives in symbiosis with the plant without forming a mycorrhiza. The liquid medium contains a growth substrate of the nonmycorrhizal filamentous fungus. The method includes applying the liquid formulation to a terrestrial part of the plant or infiltrating the liquid formulation into a subterranean part of the plant. The liquid formulation contains a mycelium being at least one of inocula grown in the growth substrate. The inocula result from isolation and culturing of a first function filamentous fungus and a second function filamentous fungus. The first function filamentous fungus has a first function of a plurality of adjusting functions set to artificially adjust a biome of rhizosphere of the plant. The second function filamentous fungus has a second function of the plurality of adjusting functions. The second function is different from the first function (hereafter, this embodiment may be referred to as Embodiment E3).

In Embodiment E3, the plurality of adjusting functions may be two or more functions selected from the group consisting of promoting the growth of the plant, protecting the plant against a disease fungus, improving acclimation of the plant to reduce emission of greenhouse gases, and increasing diversity of the biome of rhizosphere of the plant (hereafter, this embodiment may be referred to as Embodiment E4).

In Embodiment E4, the first function filamentous fungus may be specified as a growth promoting filamentous fungus to promote the growth of the plant. The second function filamentous fungus may be specified as a protecting filamentous fungus to protect the plant against a disease fungus. The plant may be rooted and grown in a compost containing the growth promoting filamentous fungus. The liquid formulation containing a mycelium of the protecting filamentous fungus may be applied to a terrestrial part of the grown plant or infiltrated into a subterranean part of the grown plant (hereafter, this embodiment may be referred to as Embodiment E5).

The method according to Embodiment E4 may further include analyzing a biome of soil at a planting site at which the plant is planted or in a neighborhood of the planting site, and specifying, from nonmycorrhizal filamentous fungi included in the biome, a growth promoting filamentous fungus to promote the growth of the plant and a protecting filamentous fungus to protect the plant against a disease fungus as the plurality of adjusting functions. The liquid formulation may include a first liquid formulation and a second liquid formulation. The first liquid formulation may contain a mycelium of the growth promoting filamentous fungus, and the second liquid formulation may contain a mycelium of the protecting filamentous fungus. The liquid formulation may be a mixed agent containing mycelia of the growth promoting filamentous fungus and the protecting filamentous fungus (hereafter, this embodiment may be referred to as Embodiment E6).

In Embodiment E2 or Embodiment E6, the protecting filamentous fungus may be a coexistent protection fungus coexisting with the growth promoting filamentous fungus. The method according to Embodiment E2 or Embodiment E6 may further include applying a first liquid formulation containing a mycelium of the growth promoting filamentous fungus to a terrestrial part of the plant or infiltrating the first liquid formulation into a subterranean part of the plant in a seedling stage of the plant, and applying a second liquid formulation containing a mycelium of the protecting filamentous fungus to a terrestrial part of the plant grown past the seedling stage or infiltrating the second liquid formulation into a subterranean part of the plant grown past the seedling stage (hereafter, this embodiment may be referred to as Embodiment E7).

In some embodiments, a plant growing device is provided. The plant growing device is a device for introducing a liquid formulation for artificially growing a plant into a cultivation system including a subterranean part included in a rhizosphere of the plant and a terrestrial part of the plant. The liquid formulation contains a nonmycorrhizal filamentous fungus grown in a liquid medium containing a growth substrate of the nonmycorrhizal filamentous fungus. The nonmycorrhizal filamentous fungus lives in symbiosis with the plant without forming a mycorrhiza. The liquid formulation contains a mycelium being inocula grown in the liquid medium. The inocula result from isolation and culturing of a first function filamentous fungus and a second function filamentous fungus. The first function filamentous fungus has a first function of a plurality of adjusting functions set to artificially adjust a biome of rhizosphere of the plant. The second function filamentous fungus has a second function of the plurality of adjusting functions. The second function is different from the first function. The plant growing device includes a liquid holder to hold the liquid formulation and an introducer to apply the liquid formulation held by the liquid holder to the terrestrial part of the plant or to infiltrate the liquid formulation into the subterranean part of the plant (hereafter, this embodiment may be referred to as Embodiment E8).

### Example 1

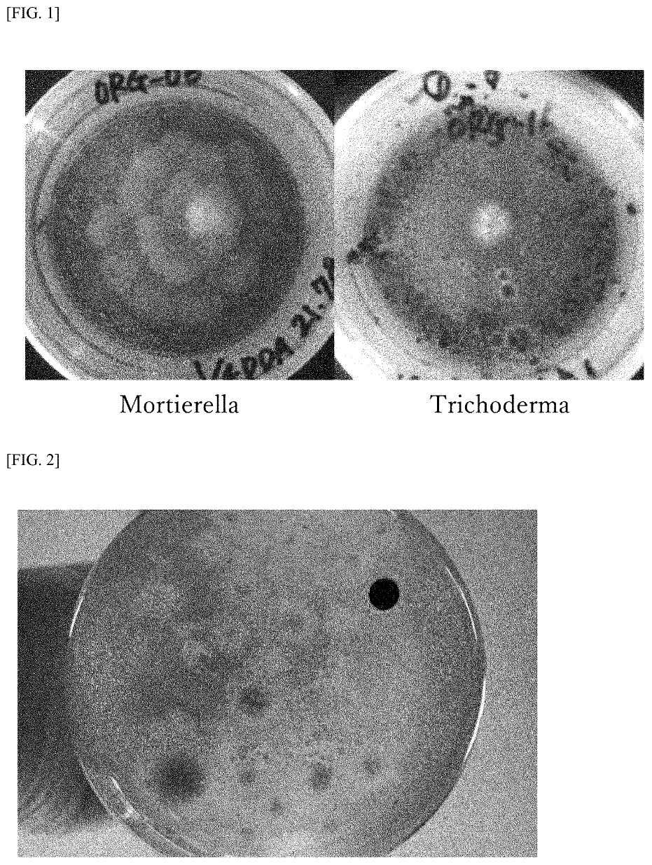

In Example 1, field work was conducted over a secondary forest located around a site (planting site) at which a growing plant was to be planted (within a radius of about 10 km from the site). Root slices of an indigenous plant (origin plant, or more specifically, Alnus pendula) were used as samples, and microorganisms living in symbiosis with the rhizosphere of the indigenous plant were isolated. Gene sequence information obtained with the isolated microorganisms was compared with a database to specify a filamentous fungus of Trichoderma genus classified into Ascomycetes as a protecting filamentous fungus with a protection function and specify a filamentous fungus of Mortierella genus classified into Zygomycetes as a growth promoting filamentous fungus with a growth promotion function. These filamentous fungi were isolated and cultured using a PDA agar medium to be used as inocula (FIG. 1). In FIG. 1, a filamentous fungus of Mortierella genus is cultured in a left laboratory dish, and a filamentous fungus of Trichoderma genus is cultured in a right laboratory dish.

A liquid medium containing a growth substrate to grow inocula was prepared from a commercially available gardening liquid fertilizer. The undiluted fertilizer was diluted 100-fold and sterilized with an autoclave. The liquid fertilizer contains an extract of vegetable tissues, with a total nitrogen content of 3%, an aqueous phosphorus acid content of 3%, and an aqueous potassium content of 2% contained as fertilizer components. The specified dilution ratio of the liquid fertilizer was 1000-fold. A medium slice of about 3 cm containing colonies of inocula of fungi of Mortierella genus cultured on the agar medium was placed into a liquid medium obtained by diluting this liquid fertilizer 100-fold. An appropriate amount of the liquid medium inoculated with the inocula was placed in a shaking culture flask, and cultured on a shaking culture device for three days at about 23° C. at 150 to 170 rpm.

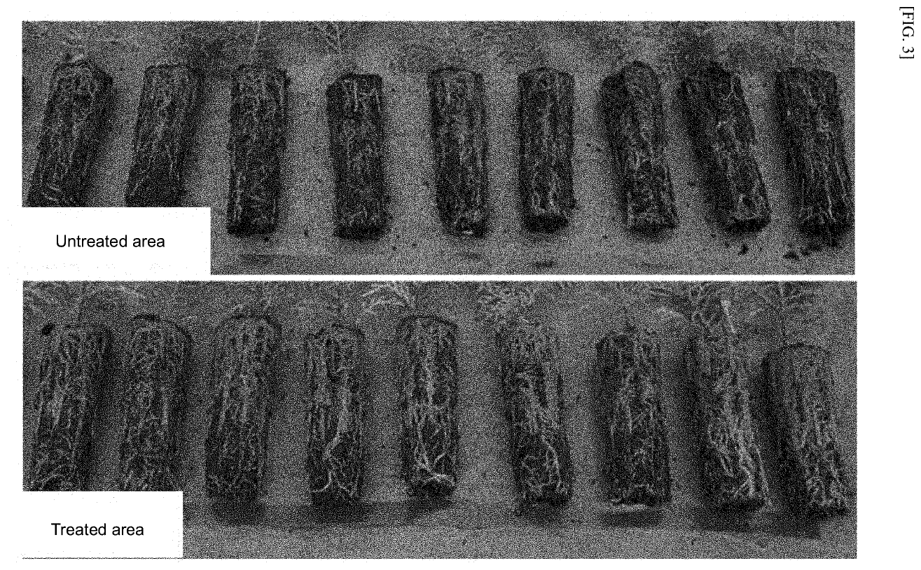

The resulting culture medium was visually identified as having a substantially spherical lump of a mycelium (mycelium lump) of the inoculated filamentous fungus and having the mycelium fully grown with the growth substrate (FIG. 2). The resulting microorganism liquid formulation (plant growing composite) was a 10-fold dilution of the liquid medium (culture medium) in which the inocula were grown. The dilution factor of the liquid medium to the undiluted liquid fertilizer was 1000-fold.

A seedling of Japanese cypress grown for less than one year in the compost for growing a seedling and placed in a 200-ml container was irrigated with 50 ml of the obtained microorganism liquid formulation per 200 ml of the compost in capacity ratio. A commercially available measuring cup or a syringe was used for the irrigation.

### Comparative Example 1

In Comparative Example 1, the gardening liquid fertilizer used in Example 1 was diluted 1000-fold without being inoculated with inocula. Seedlings of Japanese cypress grown for less than one year under the same conditions as in Example 1 were irrigated with the resulting liquid fertilizer as a liquid formulation to grow the seedlings.

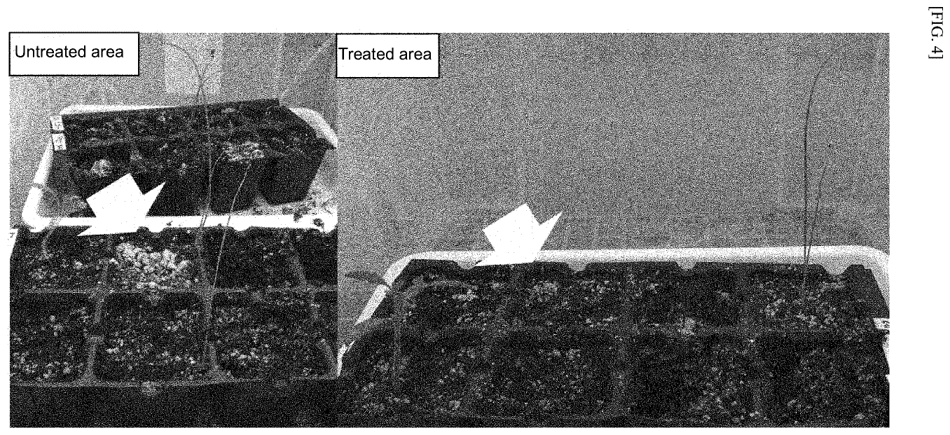

FIG. 3 shows photos of the roots of Japanese cypress seedlings grown in Example 1 (treated area) and Comparative Example 1 (untreated area) for four weeks after irrigation with the liquid formulation. As shown in the lower portion in FIG. 3, the seedlings irrigated with the microorganism liquid formulation in Example 1 inoculated with the inoculum having the growth promotion function had the roots grown further than the seedlings grown in Comparative Example 1 shown in the upper portion in FIG. 3, and had tighter roots in the volume of the seedling growing container.

### Example 2

In Example 2, seedlings of edible Welsh onion and tomato were grown as target plants.

In Example 2, the field in which the Welsh onion is grown year round (successively) was used as the planting site, and a soil microbiome was analyzed with environmental DNA analysis at the planting site. The soil microbiome analysis at the planting site shows that the soil contained fungi of Fusarium genus as pathogenic fungi for the Welsh onion. Thus, the site about 100 km away in a linear distance from the planting site but contiguous with the site was determined as the neighborhood of the planting site. Samples were collected from indigenous plant roots inhabiting the neighborhood forest to isolate multiple nonmycorrhizal filamentous fungi that can be isolated and cultured.

Gene sequence information for the isolated strain was obtained and compared with a database to specify a filamentous fungus of Trichoderma genus classified into Ascomycetes as a protecting filamentous fungus against Fusarium pathogenic fungi. The isolated strain was used as an inoculum, and the microorganism liquid formulation inoculated with the inoculum was prepared in the same manner as in Example 1. As a liquid medium containing the growth substrate, an undiluted commercially available gardening liquid fertilizer was used. The liquid fertilizer contains a decomposition product of yeast cell walls, with a total nitrogen content of 1%, an aqueous phosphorus acid content of 5%, and an aqueous potassium content of 5% contained as fertilizer components.

Seeds of Welsh onion and tomato were sown in the compost for growing a seedling placed in a commercially available seedling growing pot. On the seedlings two weeks after germinated, the microorganism liquid formulation containing mycelia derived from the inoculum grown by using the protecting filamentous fungus was sprinkled. The liquid formulation was equally sprinkled using a syringe, with about 50 ml of a 1000-fold dilute solution per pot. After the protecting filamentous fungus was sprinkled as the liquid formulation, a microorganism liquid formulation inoculated with Fusarium pathogenic fungi as inocula was prepared in the same manner, and sprinkled on the compost for growing a seedling of Welsh onion and tomato.

### Comparative Example 2

In Comparative Example 2, the gardening liquid fertilizer used in Example 2 was diluted 1000-fold without being inoculated with inocula. The resulting liquid fertilizer as a liquid formulation was sprinkled on Welsh onion and tomato seedlings under the same conditions as in Example 2. A microorganism liquid formulation inoculated with Fusarium pathogenic fungi as inocula was then prepared in the same manner and sprinkled to grow the seedlings.

The surfaces of the compost for growing seedlings of the Welsh onion and tomato one week after the sprinkle of the liquid formulation were compared. Compared with the compost for growing a seedling on which the liquid formulation not inoculated with an inoculum in Comparative Example 2 is sprinkled (on the left in FIG. 4), the compost for growing a seedling on which the microorganism liquid formulation inoculated with an inoculum with the protection function in Example 2 was sprinkled (on the right in FIG. 4) had no white spores of Fusarium pathogenic fungi spreading over the soil surface. The compost for growing a seedling and the seedlings grown in the compost were protected from infection with Fusarium pathogenic fungi.

As described above, the technique according to one or more embodiments of the disclosure can protect plants against infection with pathogenic fungi by irrigation with or sprinkling of the microorganism liquid formulation obtained by growing the protecting nonmycorrhizal filamentous fungi isolated from the neighborhood of the site at which the plant seedlings are planted.

### Example 3

### Manufacture of Plant Growing Composite

A fungus of Trichoderma genus was used as a functional filamentous fungus, and a plant growing composite containing the functional filamentous fungus was manufactured in the manner below. First, a functional filamentous fungus isolated and cultured on an agar medium was cut into an about 3-cm square with the agar medium, and the cut piece of the functional filamentous fungus with the agar medium was placed into 100 mL of a sterilized liquid medium contained in a sterilized 200-mL triangular flask. Subsequently, the functional filamentous fungus underwent shaking culture at 160 rpm using a shaker. The functional filamentous fungus was cultured for three days at room temperature (about 25° C.) to obtain a culture medium serving as a plant growing composite. The liquid medium used as a YBS liquid medium contained 5 g/L of beer yeast, 20 g/L of rice bran, and 10 g/L of sucrose. Calculation of Mycelium Percentage

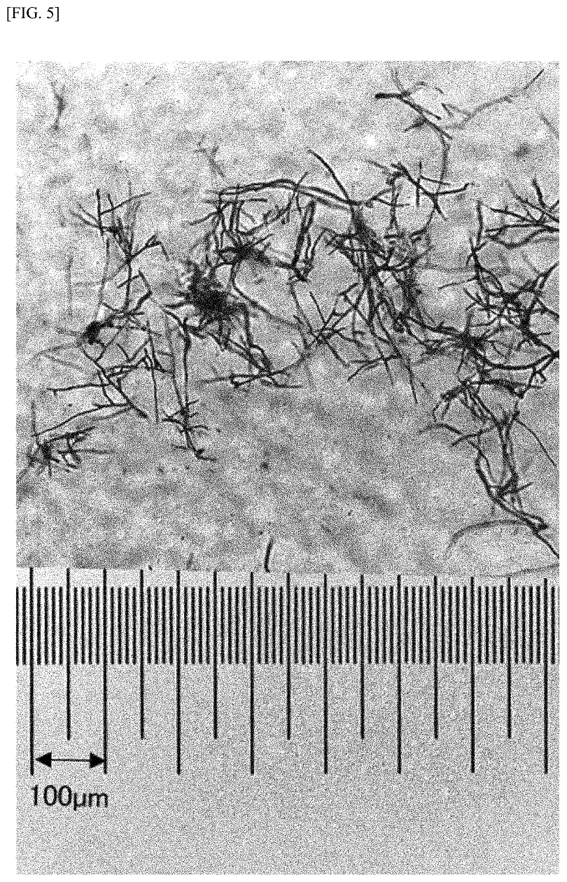

FIG. 5 is a microscopic photo of the plant growing composite in Example 3. Of the functional filamentous fungi contained in the plant growing composite, the percentage of mycelia (mycelium percentage) was calculated in the manner below: First, the functional filamentous fungus contained in the plant growing composite obtained in Manufacture of Plant Growing Composite described above was dispersed in the same manner as in the above dispersion process. The functional filamentous fungus was dispersed with a blender from Hamilton Beach Brands, Inc. (Model No. HBH450), at 20000 rpm in about 20 to 30 seconds. Subsequently, a small amount of the dispersed plant growing composite was stained with methyl blue, and observed with an optical microscope (biological microscope with built-in digital camera DN-107T from AS ONE CORPORATION) at 100-fold magnification, and the photo was taken (FIG. 5). The taken photo underwent image analysis using a piece of free software GNU Image Manipulation Program (GIMP) to calculate, in the visual field of the photo, an area (number of pixels) Sm occupied by mycelia and an area (number of pixels) S_{sc} occupied by sporophytes, acervuli, or both (hereafter may be referred to as sporophytes and others).

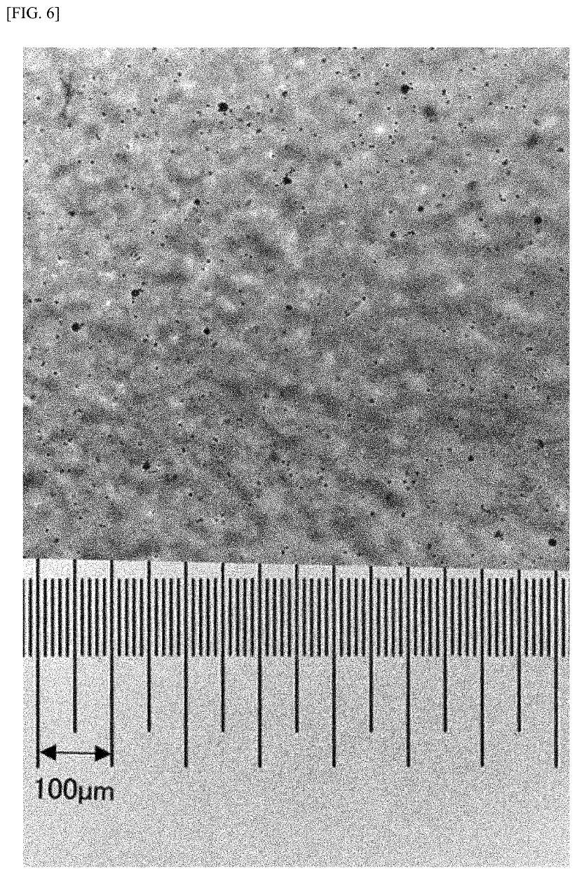

FIG. 6 is a microscopic photo of sporophytes of the same filamentous fungus as in FIG. 5. When calculating the area Sm occupied by mycelia and the area S_{sc} occupied by sporophytes and others, persons having ordinary skill in the art can easily distinguish mycelia from sporophytes and others, as is clear from the comparison between FIGS. 5 and 6. Mycelia and sporophytes and others can be distinguished from each other with reference to an aspect ratio (longitudinal dimension/shorter dimension) of a predetermined reference value (hereafter may also be referred to as an aspect ratio reference value). For example, the area having an aspect ratio higher than or equal to the reference value is determined to be occupied by mycelia, and the area having an aspect ratio lower than the reference value is determined to be occupied by sporophytes and others. The aspect ratio reference value may be, for example, 2, 3, 4, 5, or 10. Distinguishing between mycelia and sporophytes and others using the aspect ratio may be performed by a computer-based image analysis. When the dispersed plant growing composite is too thick, the composite is diluted as appropriate for observation and photographing. When the composite is too thin, the composite is concentrated as appropriate (by, for example, centrifugation or filter concentration) for observation and photographing.

The mycelium percentage Rₘ (%) is calculated from the formula below based on the area Sm and the area S_{sc} obtained as above. The mycelium percentage in FIG. 5 was about 98 to 99%.

$${R}_{m} = {S}_{m} / ( {S}_{m} + {S}_{sc} ) \times 100$$

### Examined Example 1

The composition of the liquid medium used in the liquid culture process was examined in the manner below.

### Manufacture of Liquid Medium

YBS liquid media M01 to M13 shown in Table 1 or 2 were manufactured in the manner described below. More specifically, liquid media were prepared with the compositions shown in Table 1 or 2 except for rice bran, and sterilized in an autoclave. Subsequently, 10 ml of each sterilized liquid medium was placed in a 55-mm laboratory dish, and separately sterilized rice bran was placed in the laboratory dish by the amount listed in Table 1 or 2.

### Liquid Culture Experiment

A functional filamentous fungus isolated and stored on a solid medium was inoculated to, with a platinum loop, each laboratory dish receiving the medium as described in Manufacture of Liquid Medium. For the liquid media M01 to M09, fungi of Mortierella genus and fungi of Trichoderma genus were used as functional filamentous fungi. For the liquid media M10 to M13, fungi of Mortierella genus, fungi of Trichoderma genus, and fungi of Helotiales order (Helotiales sp.) were used as functional filamentous fungi, and a negative control (control) containing no functional filamentous fungus was also prepared. Laboratory dishes inoculated with the functional filamentous fungus (and the control) were cultured at room temperature (about 25° C.) for about one or two weeks without being shaken, and observed for the growth of mycelia. The liquid medium in the laboratory dish had a depth of about 1 mm, and thus was determined to be under aerobic conditions without being shaken.

### Results

Tables 1 and 2 show the results of the liquid culture experiment. In Mycelium Growth in the tables, the sign—indicates that no growth of a mycelium was visually observed in the laboratory dish. The sign+indicates that a mycelium was observed in less than 50% of the base area of the laboratory dish. The sign++indicates that a mycelium was observed in greater than or equal to 50% and less than 100% of the base area of the laboratory dish. The sign+++indicates that a mycelium was observed in about 100% of the base area of the laboratory dish. The sign++++indicates that a mycelium was observed in about 100% of the base area of the laboratory dish and that the mycelium had grown also in the thickness direction of the laboratory dish. The sign * indicates fewer or slow formations of sporophytes and others.

TABLE 1

| | | | M01 | M02 | M03 | M04 | M05 | M06 | M07 | M08 | M09 |
|---|---|---|---|---|---|---|---|---|---|---|---|
| Medium | Beer Yeast | [g/L] | 0 | 2 | 5 | 0 | 2 | 5 | 0 | 2 | 5 |
| Composition | Rice Bran | [g/L] | 0 | 0 | 0 | 20 | 20 | 20 | 50 | 50 | 50 |
| | Sucrose | [g/L] | 10 | 10 | 10 | 10 | 10 | 10 | 10 | 10 | 10 |
| Mycelium | Mortierella | 1 week | − | + | ++ | +++ | +++ | ++++ | +++ | +++ | ++++ |
| Growth | Trichoderma | 1 week | + | ++ | +++ | +++ | +++ | ++++ | +++* | +++* | ++++ |

*Less spore formation

TABLE 2

| | | | M10 | M11 | M12 | M13 |
|---|---|---|---|---|---|---|
| Medium | Beer Yeast | [g/L] | 5 | 5 | 5 | 5 |
| Composition | Rice Bran | [g/L] | 20 | 20 | 20 | 20 |
| | Sucrose | [g/L] | 0 | 10 | 20 | 30 |
| Mycelium | Mortierella | 1 week | +++ | ++++ | ++++ | ++++ |
| Growth | | 2 weeks | ++++ | ++++ | ++++ | ++++ |
| | Trichoderma | 1 week | ++++ | ++++ | ++++* | ++++* |
| | | 2 weeks | ++++ | ++++ | ++++ | ++++ |
| | Helotiales sp. | 1 week | − | + | + | + |
| | | 2 weeks | ++ | +++ | ++ | ++ |
| | Control | 1 week | − | − | − | − |
| | | 2 weeks | − | − | − | − |

*Less spore formation

Aspects of the disclosure provide plant growing composites (1) to (7), methods for manufacturing the plant growing composite (8), (10) to (15), and methods for growing a plant (9), (16) are described below.

(1) A plant growing composite to be applied to a growing plant before, after, or before and after the growing plant is planted, the growing plant being a plant to be planted at a planting site and grown artificially, the plant growing composite comprising:
a liquid substrate; and
a mycelium of a functional filamentous fungus being nonmycorrhizal, the functional filamentous fungus having a function contributable to growth or a growing environment of the growing plant,
wherein the functional filamentous fungus is derived from a nonmycorrhizal filamentous fungus isolated from a sample collected from the planting site or a neighborhood of the planting site, and
wherein the mycelium constitutes more than or equal to 50% of the functional filamentous fungus included in the plant growing composite.

(2) The plant growing composite according to (1), wherein the substrate contains greater than or equal to 1 g/L of a saccharide.

(3) The plant growing composite according to (1) or (2), wherein
the mycelium is derived from a culture being the functional filamentous fungus cultured in a liquid medium under an aerobic condition, and
at least a part of the substrate is derived from the liquid medium.

(4) The plant growing composite according to (3), wherein
the liquid medium has a carbon to nitrogen ratio of 1.5 to 30 inclusive.

(5) The plant growing composite according to any one of (1) to (4), wherein
the mycelium constitutes more than or equal to 80% of the functional filamentous fungus included in the plant growing composite.

(6) The plant growing composite according to any one of (1) to (5), wherein
the functional filamentous fungus has one or more functions selected from the group consisting of
promoting the growth of the growing plant,
protecting the growing plant from at least one of a disease fungus or a pest,
increasing diversity of a biome of rhizosphere of the growing plant,
enhancing resistance of the growing plant against abiotic stress, and
modifying the biome of the rhizosphere of the growing plant.

(7) The plant growing composite according to any one of (1) to (6), wherein
when the plant growing composite is applied to soil at the planting site, and amplicon sequence analysis is performed on a microbiome in the soil before the plant growing composite is applied and two weeks after the plant growing composite is applied using a primer targeting at least a part of an internal transcribed spacer region, a difference in fungi community constitution at a genus level before and after the plant growing composite is applied is greater than or equal to 0.3 in beta diversity in Bray-Curtis dissimilarity.

(8) A method for manufacturing a plant growing composite to be applied to a growing plant before, after, or before and after the growing plant is planted, the growing plant being a plant to be planted at a planting site and grown artificially, the method comprising:
specifying the planting site;
specifying a functional filamentous fungus having a function contributable to growth or a growing environment of the growing plant from nonmycorrhizal filamentous fungi isolated from a sample collected from the planting site or a neighborhood of the planting site; and
culturing the specified functional filamentous fungus to obtain the plant growing composite including a liquid substrate and a mycelium of the functional filamentous fungus,
wherein the mycelium constitutes more than or equal to 50% of the functional filamentous fungus included in the plant growing composite.

(9) A method for growing a plant, the method comprising:
applying the plant growing composite according to any one of (1) to (7) to a growing plant.

(10) The method for manufacturing the plant growing composite according to (8), wherein
the substrate contains greater than or equal to 1 g/L of a saccharide.

(11) The method for manufacturing the plant growing composite according to (8) or (10), wherein
the mycelium is derived from a culture being the functional filamentous fungus cultured in a liquid medium under an aerobic condition, and
at least a part of the substrate is derived from the liquid medium.

(12) The method for manufacturing the plant growing composite according to any one of (8), (10) to (11), wherein
the liquid medium has a carbon to nitrogen ratio of 1.5 to 30 inclusive.

(13) The method for manufacturing the plant growing composite according to any one of (8), (10) to (12), wherein
the mycelium constitutes more than or equal to 80% of the functional filamentous fungus included in the plant growing composite.

(14) The method for manufacturing the plant growing composite according to any one of (8), (10) to (13), wherein
the functional filamentous fungus has one or more functions selected from the group consisting of
promoting the growth of the growing plant,
protecting the growing plant from at least one of a disease fungus or a pest,
increasing diversity of a biome of rhizosphere of the growing plant,
enhancing resistance of the growing plant against abiotic stress, and
modifying the biome of the rhizosphere of the growing plant.

(15) The method for manufacturing the plant growing composite according to any one of (8), (10) to (14), wherein
when the plant growing composite is applied to soil at the planting site, and amplicon sequence analysis is performed on a microbiome in the soil before the plant growing composite is applied and two weeks after the plant growing composite is applied using a primer targeting at least a part of an internal transcribed spacer region, a difference in fungi community constitution at a genus level before and after the plant growing composite is applied is greater than or equal to 0.3 in beta diversity in Bray-Curtis dissimilarity.

(16) A method for growing a plant, the method comprising: applying the plant growing composite manufactured with the method according to any one of (8), (10) to (15) to a growing plant.

1. A plant growing composite to be applied to a growing plant before, after, or before and after the growing plant is planted, the growing plant being a plant to be planted at a planting site and grown artificially, the plant growing composite comprising:
a liquid substrate; and
a mycelium of a functional filamentous fungus being nonmycorrhizal, the functional filamentous fungus having a function contributable to growth or a growing environment of the growing plant,
wherein the functional filamentous fungus is derived from a nonmycorrhizal filamentous fungus isolated from a sample collected from the planting site or a neighborhood of the planting site, and
wherein the mycelium constitutes more than or equal to 50% of the functional filamentous fungus included in the plant growing composite.

2. The plant growing composite according to claim 1, wherein
the substrate contains greater than or equal to 1 g/L of a saccharide.

3. The plant growing composite according to claim 1, wherein
the mycelium is derived from a culture being the functional filamentous fungus cultured in a liquid medium under an aerobic condition, and
at least a part of the substrate is derived from the liquid medium.

4. The plant growing composite according to claim 3, wherein
the liquid medium has a carbon to nitrogen ratio of 1.5 to 30 inclusive.

5. The plant growing composite according to claim 1, wherein
the mycelium constitutes more than or equal to 80% of the functional filamentous fungus included in the plant growing composite.

6. The plant growing composite according to claim 1, wherein
the functional filamentous fungus has one or more functions selected from the group consisting of
promoting the growth of the growing plant,
protecting the growing plant from at least one of a disease fungus or a pest,
increasing diversity of a biome of rhizosphere of the growing plant,
enhancing resistance of the growing plant against abiotic stress, and
modifying the biome of the rhizosphere of the growing plant.

7. The plant growing composite according to claim 1, wherein
when the plant growing composite is applied to soil at the planting site, and amplicon sequence analysis is performed on a microbiome in the soil before the plant growing composite is applied and two weeks after the plant growing composite is applied using a primer targeting at least a part of an internal transcribed spacer region, a difference in fungi community constitution at a genus level before and after the plant growing composite is applied is greater than or equal to 0.3 in beta diversity in Bray-Curtis dissimilarity.

8. A method for manufacturing a plant growing composite to be applied to a growing plant before, after, or before and after the growing plant is planted, the growing plant being a plant to be planted at a planting site and grown artificially, the method comprising:
specifying the planting site;
specifying a functional filamentous fungus having a function contributable to growth or a growing environment of the growing plant from nonmycorrhizal filamentous fungi isolated from a sample collected from the planting site or a neighborhood of the planting site; and
culturing the specified functional filamentous fungus to obtain the plant growing composite including a liquid substrate and a mycelium of the functional filamentous fungus,
wherein the mycelium constitutes more than or equal to 50% of the functional filamentous fungus included in the plant growing composite.

9. A method for growing a plant, the method comprising:
applying the plant growing composite according to claim 1 to a growing plant.

10. The method for manufacturing the plant growing composite according to claim 8, wherein
the substrate contains greater than or equal to 1 g/L of a saccharide.

11. The method for manufacturing the plant growing composite according to claim 8, wherein
the mycelium is derived from a culture being the functional filamentous fungus cultured in a liquid medium under an aerobic condition, and
at least a part of the substrate is derived from the liquid medium.

12. The method for manufacturing the plant growing composite according to claim 11, wherein
the liquid medium has a carbon to nitrogen ratio of 1.5 to 30 inclusive.

13. The method for manufacturing the plant growing composite according to claim 8, wherein
the mycelium constitutes more than or equal to 80% of the functional filamentous fungus included in the plant growing composite.

14. The method for manufacturing the plant growing composite according to claim 8, wherein
the functional filamentous fungus has one or more functions selected from the group consisting of
promoting the growth of the growing plant,
protecting the growing plant from at least one of a disease fungus or a pest,
increasing diversity of a biome of rhizosphere of the growing plant,
enhancing resistance of the growing plant against abiotic stress, and
modifying the biome of the rhizosphere of the growing plant.

15. The method for manufacturing the plant growing composite according to claim 8, wherein
when the plant growing composite is applied to soil at the planting site, and amplicon sequence analysis is performed on a microbiome in the soil before the plant growing composite is applied and two weeks after the plant growing composite is applied using a primer targeting at least a part of an internal transcribed spacer region, a difference in fungi community constitution at a genus level before and after the plant growing composite is applied is greater than or equal to 0.3 in beta diversity in Bray-Curtis dissimilarity.

16. A method for growing a plant, the method comprising:
applying the plant growing composite manufactured with the method according to claim 8 to a growing plant.
